(19) United States
(12) Patent Application Publication
(10) Pub. No.: US 2018/0159460 A1
(43) Pub. Date: Jun. 7, 2018

(54) Systems and Methods for Integrated Thermophotovoltaic Conversion

(71) Applicants: Walker Chan, Cambridge, MA (US); Ivan Celanovic, Cambridge, MA (US); John D. Joannopoulos, Belmont, MA (US); Marin Soljacic, Belmont, MA (US); Veronika Stelmakh, Cambridge, MA (US)

(72) Inventors: Walker Chan, Cambridge, MA (US); Ivan Celanovic, Cambridge, MA (US); John D. Joannopoulos, Belmont, MA (US); Marin Soljacic, Belmont, MA (US); Veronika Stelmakh, Cambridge, MA (US)

(21) Appl. No.: 15/833,027

(22) Filed: Dec. 6, 2017

Related U.S. Application Data
(60) Provisional application No. 62/430,411, filed on Dec. 6, 2016.

(51) Int. Cl. H02S 10/30

(52) U.S. Cl. CPC H02S 10/30

(57) ABSTRACT

An apparatus for generating electricity via thermophotovoltaic (TPV) energy conversion includes a metallic combustor to convert fuel into heat. The apparatus also includes a metallic photonic crystal to emit electromagnetic radiation within a predetermined wavelength band in response to receiving the heat from the combustor. A brazing layer is disposed between the combustor and the photonic crystal to couple the combustor with the photonic crystal. The apparatus also includes a photovoltaic cell, in electromagnetic communication with the photonic crystal, to convert the electromagnetic radiation emitted by the photonic crystal into electricity.

### CROSS-REFERENCES TO RELATED APPLICATIONS

This application claims the priority benefit under 35 U.S.C. § 119(e) of U.S. Application No. 62/430,411, filed Dec. 6, 2016, entitled “INTEGRATED THERMOPHOTOVOLTAIC SYSTEM,” which is hereby incorporated herein by reference in its entirety.

### GOVERNMENT SUPPORT

This invention was made with Government support under Grant No. DE-SC0001299 awarded by the Department of Energy, Grant No. W911NF-08-2-0004 awarded by the U.S. Army Research Development and Engineering Command, and Grant No. W911NF-13-D-0001 awarded by the Army Research Office. The Government has certain rights in the invention.

### BACKGROUND

Batteries are currently the mainstream energy source at small scales (e.g., less than 100 W) and their energy output is already close to the theoretical limit. In contrast, the energy density of hydrocarbon fuels is 60 times greater than the energy density of batteries. In other words, a 1.5% fuel-to-electricity conversion efficiency of a hydrocarbon fuel-to-electricity converter corresponds to the energy density of lithium ion batteries. Therefore, harnessing the energy content of hydrocarbon fuels on the mesoscale can pave the way to transformative increases in portable power generation. Mesoscale generators can also fill the gap between batteries and conventional mechanical generators.

There are currently several active approaches for mesoscale fuel-to-electricity conversion, including micro-mechanical heat engines, fuel cells, thermoelectrics, and thermophotovoltaics (TPV). One type of thermophotovoltaic device includes a combustor, a selective emitter, and one or more photovoltaic (PV) cells. However, several challenges severely limit the feasibility of a practical TPV system. For example, the combustor and the selective emitter are usually made of different materials and therefore have different thermal expansions coefficients. At high temperatures during operation (e.g., greater than 900° C.), this mismatch in thermal expansion can generate high thermo-mechanical stresses that can deform the selective emitter and/or the combustor, thereby compromising the performance of the TPV system. In addition, these TPV systems also suffer from unsatisfactory optical performance of the selective emitter (e.g., emission at undesired wavelengths) and stable integration of the emitter with combustor, as well as a lack of refractory metal substrates having high-temperature thermo-chemical stability and large-area wafer-quality to fabricate the photonic crystal.

### SUMMARY

Embodiments of the present invention include apparatus, systems, and methods for integrated thermophotovoltaic energy conversion. In one example, an apparatus for generating electricity via thermophotovoltaic (TPV) energy conversion includes a combustor to convert fuel into heat and the combustor includes a first metal. The apparatus also includes a photonic crystal, in thermal communication with the combustor, to emit electromagnetic radiation within a predetermined wavelength band in response to receiving the heat from the combustor. The photonic crystal includes a second metal different from the first metal. A brazing layer is disposed between the combustor and the photonic crystal to couple the combustor with the photonic crystal. The brazing layer includes a brazing material. The apparatus also includes a photovoltaic cell, in electromagnetic communication with the photonic crystal, to convert the electromagnetic radiation emitted by the photonic crystal into electricity.

In another example, a method of thermophotovoltaic energy conversion includes burning fuel in a combustor to generate heat. The heat causes a photonic crystal, in thermal communication with the combustor and including a second metal, to emit electromagnetic radiation within a predetermined wavelength band. The combustor and the photonic crystal are coupled by a brazing layer comprising a brazing material. The method also includes generating electricity from the electromagnetic radiation emitted by the photonic crystal with a photovoltaic cell in electromagnetic communication with the photonic crystal.

In yet another example, a thermophotovoltaic device includes a combustor to convert fuel into heat. The combustor includes a substrate made of Inconel and defining a serpentine channel to guide the fuel. The serpentine channel has a first external wall and a second external wall opposite the first external wall. The combustor also includes a first metal plate coupled to the first external wall by a first brazing layer and a second metal plate coupled to the second external wall by a second brazing layer. The first metal plate and the second metal plate substantially seal the combustor. The thermophotovoltaic device also includes a photonic crystal, in thermal communication with the combustor, to convert the heat from the combustor into electromagnetic radiation within a predetermined wavelength band. The photonic crystal includes a metal substrate defining a two-dimensional (2D) array of holes and dielectric material disposed in the 2D array of holes. A third brazing layer is disposed between the combustor and the photonic crystal to couple the combustor with the photonic crystal. The third brazing layer includes a brazing material diffused into at least one of the combustor or the photonic crystal. The brazing material includes nickel doped with at least one of silicon or boron. The thermophotovoltaic device also includes a photovoltaic cell, in electromagnetic communication with the photonic crystal, to convert the electromagnetic radiation emitted by the photonic crystal into electricity.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a schematic of an integrated thermophotovoltaic (TPV) device including a brazing layer to couple a metal combustor with a metal photonic crystal.

FIG. 1B illustrates the thermophotovoltaic energy conversion process in the device shown in FIG. 1A.

FIG. 2 shows a schematic of a combustor that can be used in a TPV device to generate heat by burning fuel.

FIG. 3A is an optical micrograph of a cross section of a combustor substantially similar to the combustor shown in FIG. 2.

FIG. 3B is an optical micrograph illustrating the structure at the corner of the combustor shown in FIG. 3A.

FIG. 4A shows a schematic of a photonic crystal that can be used in a TPV device to convert heat energy into electromagnetic radiation.

FIG. 4B shows simulated spectral radiance normal to the surface of the photonic crystal shown in FIG. 4A at 1000° C.

FIGS. 5A-5F illustrate a method of fabricating a photonic crystal including an array of cavities coated with a conformal dielectric layer.

FIGS. 6A-6G illustrate a method of fabricating a photonic crystal including an array of cavities defined in a metal substrate and filled with a dielectric material.

FIG. 6H is a table showing one example set of etching parameters that can be used in the method illustrated in FIGS. 6A-6G.

FIG. 7A is a scanning electron microscope (SEM) image of a photonic crystal fabricated via the method illustrated in FIGS. 6A-6G before cavity filling.

FIG. 7B is an SEM image of the photonic crystal shown in FIG. 7A after cavity filling with HfO₂.

FIG. 7C is a cross section of the photonic crystal shown in FIG. 7A after cavity filling with HfO₂.

FIGS. 7D-7F illustrate optimization of optical performance of the photonic crystal by adjusting geometrical dimensions of the photonic crystal.

FIGS. 8A and 8B show calculated and measured emittance, respectively, of a photonic crystal including a 2D array of cavities defined in a tantalum substrate and filled with HfO₂.

FIG. 9A is a focused ion beam (FIB) image of the cross section of a fabricated photonic crystal filled with HfO₂.

FIG. 9B shows simulations of emittance fitted to the measured emittance using the FIB image in FIG. 9A as the basis for the geometric model for the fitting.

FIGS. 10A and 10B show calculated emittances of two photonic crystals with different dimensions.

FIG. 11 is a table listing dimensions (in μm) of photonic crystals used in the simulation shown in FIGS. 10A and 10B.

FIG. 12A is a photo of a hot side in a TPV device integrated via diffusion brazing.

FIG. 12B shows a cross section of the TPV device shown in FIG. 12A with the channels visible.

FIG. 12C is a micrograph of a corner of the hot side assembly shown in FIG. 12B with the tantalum-Inconel braze joint visible.

FIG. 13 shows a schematic of a TPV device including a vacuum chamber to enclose a combustor integrated with a photonic crystal.

FIG. 14 is a photograph of the device shown in FIG. 13 during operation, where a diffraction pattern is visible on the photonic crystal from the ambient light.

FIG. 15 shows measured and simulated emissivity of the photonic crystal in the device shown in FIG. 13 at room temperature and at the normal incidence.

FIG. 16 shows measured and simulated electrical power output as a function of fuel flow of the device shown in FIG. 13.

FIG. 17 is a table listing parameters used in simulating performance of the device shown in FIG. 13.

FIG. 18A shows a top view of a combustor operating with air oxidizer.

FIG. 18B shows a cross sectional view of the combustor shown in FIG. 18A.

FIG. 19 shows simulated and measured operating temperature for the combustor shown in FIGS. 18A and 18B as a function of fuel flow.

FIGS. 20A and 20B show measured temperature and vacuum, respectively, during a 50+ day experiment with the combustor shown in FIGS. 18A and 18B disposed in a vacuum chamber.

FIG. 21 shows a schematic of a TPV device operating with an air oxidizer.

FIG. 22 is a photo of the TPV device shown in FIG. 21.

FIG. 23 illustrates a method of TPV energy conversion using integrated TPV devices.

### DETAILED DESCRIPTION

Overview

Apparatus, systems, and methods described herein employ an integrated thermophotovoltaic (TPV) technology that efficiently harnesses the energy content of hydro-carbon fuels in a volume that is only a fraction of a cubic inch. In this technology, a metal combustor (e.g., fueled by propane) heats a metal photonic crystal emitter to incandescence. The resulting spectrally-confined thermal radiation drives low-bandgap PV cells to generate electricity. This technology can address challenges in conventional TPV systems in several ways.

First, the combustor and photonic crystal are integrated via a brazing layer, which can sustain high temperature operation (e.g., higher than 900° C.). In addition, high-temperature alloys (e.g., Inconel) are used to fabricate the combustor to improve the thermo-mechanical stability, and polycrystalline tantalum is used to prepare large-area wafer-quality substrates for the high-temperature photonic crystal. Furthermore, the optical performance of the photonic crystal (especially at high temperatures) can be improved by depositing a passivation coating conformally on the surface of the photonic crystal and/or depositing a dielectric material in the cavities of the photonic crystal.

Systems fabricated using this integrated thermophotovoltaic technology demonstrate unprecedented heat-to-electricity efficiencies exceeding 4%, greater than the 2-3% efficiencies that were previously thought to be the practical limit. In addition, efficiency over 12% can be achieved with engineering optimization. In contrast, a 1.5% efficiency corresponds to the energy density of lithium ion batteries. Therefore, the integrated thermophotovoltaic technology described herein can open new opportunities to free portable electronics, robots, and small drones from the constraints of bulky power sources.

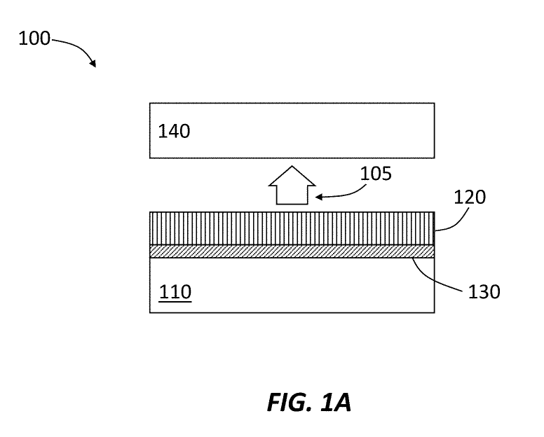

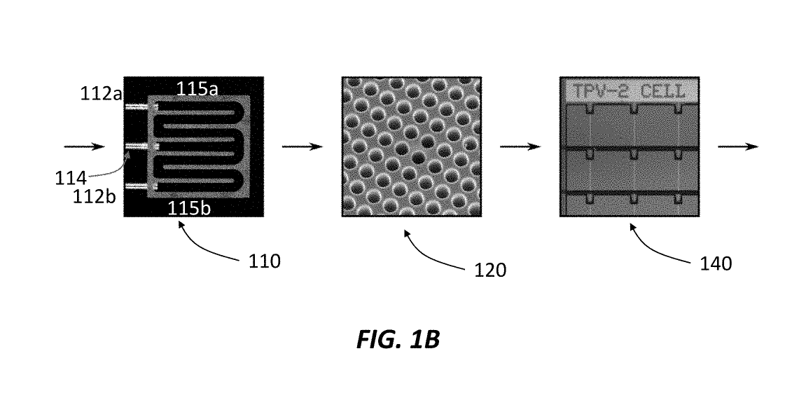

FIG. 1A shows a schematic of an integrated thermophotovoltaic device 100 including a brazing layer 130 to integrate a combustor 110 (also referred to as a microcombustor 110) and a photonic crystal 120 (also referred to as a photonic crystal emitter 120). FIG. 1B illustrates the thermophotovoltaic conversion process carried out by the device 100 shown in FIG. 1A. The combustor 100 includes a first metal (or metal alloy) that can sustain high temperature and resist oxidation during operation. The photonic crystal 120 includes a second metal (or metal alloy) that can have low optical loss. In one example, the first metal and the second metal can be the same. In this instance, the photonic crystal 120 can be defined directly on the top surface of the combustor 110 (e.g., via etching). In another example, the first metal is different from the second metal, and the brazing layer 130 is employed to integrate the combustor 110 with the photonic crystal 120. The device 100 also includes a photovoltaic (PV) cell 140 in electromagnetic communication with the photonic crystal 120 to receive electromagnetic radiation 105 emitted by the photonic crystal 120 and convert the electromagnetic radiation 105 into electricity.

In operation, the combustor 110 burns fuel (and an oxidizer, such as oxygen or air) to generate heat, which brings the photonic crystal 120 to incandescence via conduction. The heated photonic crystal 120 emits electromagnetic radiation 105 within a predetermined wavelength band that can match the band gap of the PV cell 140. Without being bound by any particular theory or mode of operation, the term “band gap” refers to the energy difference between the top of the valence band and the bottom of the conduction band of the PV cell 140. The PV cell 140 can absorb electromagnetic radiation having photon energy above the band gap. Or equivalently, the PV cell 140 can absorb electromagnetic radiation at wavelengths below the wavelength corresponding to the band gap.

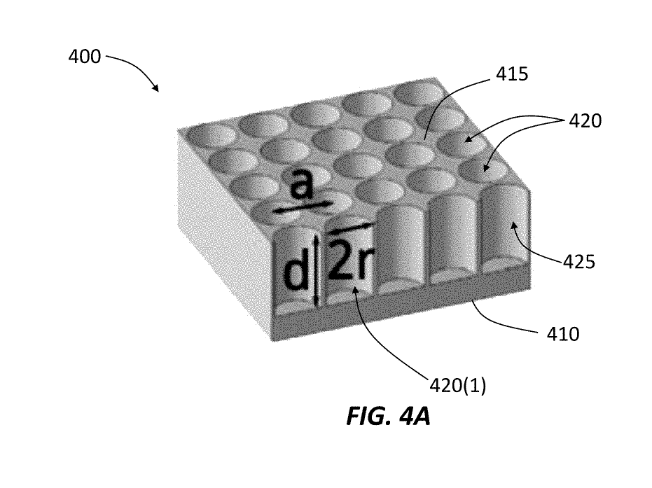

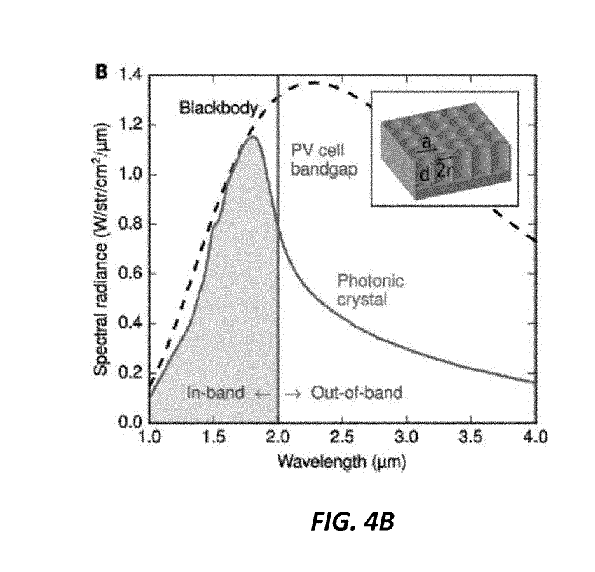

The electromagnetic radiation 105 can have a significant portion below a cutoff wavelength that corresponds to the band gap of the PV cell 140. Therefore, the portion of the electromagnetic radiation 105 below the cut-off wavelength (also referred to as in-band radiation) can be efficiently absorbed by the PV cell 140 and converted into electricity. The cutoff wavelength can be adjusted by tuning the geometries of the photonic crystal 120 (see more details below, with reference to FIGS. 4-11). Therefore, for a given PV cell 140, the photonic crystal 140 can be engineered to have a cutoff wavelength matching the band gap of the PV cell 140.

The device 100 shown in FIG. 1A has several advantages over other mesoscale fuel-to-electricity technologies. For example, the components can be integrated together such that there is no moving parts. Accordingly, the device 100 can operate free from frictional losses arising from miniaturization. The high-temperature continuous combustion process allows the device to process efficiently fuel at the mesoscale and be more readily adapted to chemically impure fuel sources, such as biofuels. Furthermore, the physical separation of the thermal components (e.g., the combustor 110 and the photonic crystal 120) and the electrical circuits (e.g., the photovoltaic cell 140) can greatly simplify the engineering efforts to manufacture the device 100. Compared to conventional TPV systems, the device 100 described herein can achieve at least two times greater conversion efficiency as discussed below with more details.

The combustor 110 can include Inconel, which includes a family of austenitic nickel-chromium-based superalloys, to sustain the high temperature during operation. For example, the Inconel can include Inconel 600, which includes about 14%-17% chromium, 6%-10% iron, and balance nickel. In operation, the temperature of the combustion in the combustor 110 can be substantially equal to or greater than 900° C. (e.g., about 900° C., about 950° C., about 1000° C., about 1100° C., about 1200° C., about 1300° C., or greater, including any values and sub ranges in between).

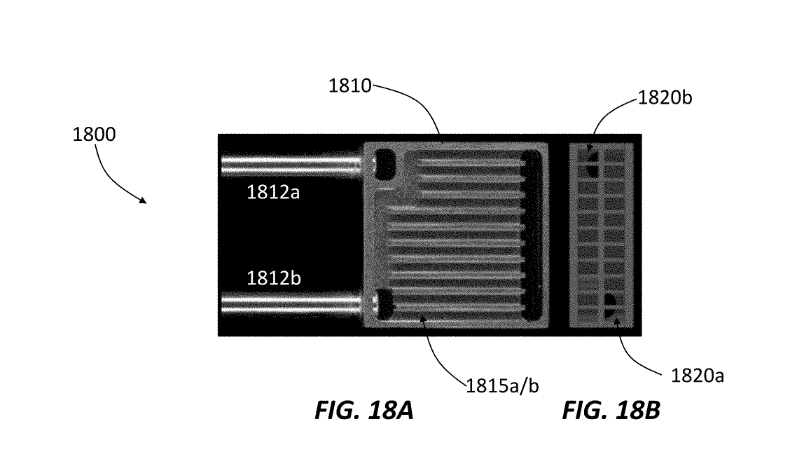

The combustor 110 usually includes one or more channels to flow the reacting fuel and air (or oxygen) mixture. In one example, as illustrated in FIG. 1B, the combustor 110 includes a first serpentine channel 115a connected to a first input tube 112a and a second serpentine channel 115b connected to a second input tube 112b. The two serpentine channels 115a and 115b share the same output tube 114. Alternatively, the input tubes 112a and 112b can be used as the output tubes, and the output tube 114 can be used as the input tube. In another example, the combustor 110 includes a single serpentine channel having one entrance and one exit. In yet another example, the combustor 110 includes an array of parallel channels to reduce the pressure drop across the combustor 110 (see, e.g., FIG. 18 below).

To facilitate the combustion of the fuel, the inner wall of the channel(s) can be coated with a combustion catalyst. For example, 5% platinum on porous alumina can be coated on the inner wall of the channel(s). For mesoscale TPV applications, the thickness of the combustor 110 can be about 5 mm to about 15 mm (e.g., about 5 mm, about 10 mm, or about 15 mm, including any values and sub ranges in between). The dimensions of the combustor 110 can be adjusted when different applications are involved.

The photonic crystal 120 can include either a one-dimensional (1D), two-dimensional (2D), or three-dimensional (3D) photonic crystal, provided that the electromagnetic radiation 105 emitted by the photonic crystal 120 is substantially within the predetermined wavelength band. For example, the photonic crystal 120 includes a metal substrate (e.g., tantalum) defining a 2D array of cavities. The 2D array has a period a, and each cavity has a radius r and a depth d. In one example, a dielectric layer (e.g., HfO₂) is conformally deposited on the surface of the photonic crystal 120 for passivation, including the inner wall of each cavity and the top surface of the photonic crystal 120. In this instance, the radius r can be about 0.4 μm to about 0.6 μm (e.g., about 0.4 μm, about 0.45 μm, about 0.5 μm, about 0.55 μm, or about 0.6 μm, including any values and sub ranges in in between), the period a can be about 0.9 μm to about 1.3 μm (e.g., about 0.9 μm, about 1.0 μm, about 1.1 μm, about 1.2 μm, or about 1.3 μm, including any values and sub ranges in between), and the depth d can be about 2 μm to about 10 μm (e.g., about 2 μm, about 3 μm, about 4 μm, about 5 μm, about 6 μm, about 7 μm, about 8 μm, about 9 μm, or about 10 μm, including any values and sub ranges in between).

In another example, each cavity can be filled with a dielectric material. In addition, an additional dielectric layer can be disposed on the photonic crystal 120. In this instance, the radius r can be about 0.15 μm to about 0.3 μm (e.g., about 0.15 μm, about 0.2 μm, about 0.25 μm, or about 0.3 μm, including any values and sub ranges in in between), the period a can be about 0.4 μm to about 1.7 μm (e.g., about 0.4 μm, about 0.45 μm, about 0.5 μm, about 0.55 μm, about 0.6 μm, about 0.65 μm, or about 0.7 μm, including any values and sub ranges in between), and the depth d can be about 2 μm to about 10 μm (e.g., about 2 μm, about 3 μm, about 4 μm, about 5 μm, about 6 μm, about 7 μm, about 8 μm, about 9 μm, or about 10 μm, including any values and sub ranges in between). More details about the photonic crystal 120 are discussed below with reference to FIGS. 4-11.

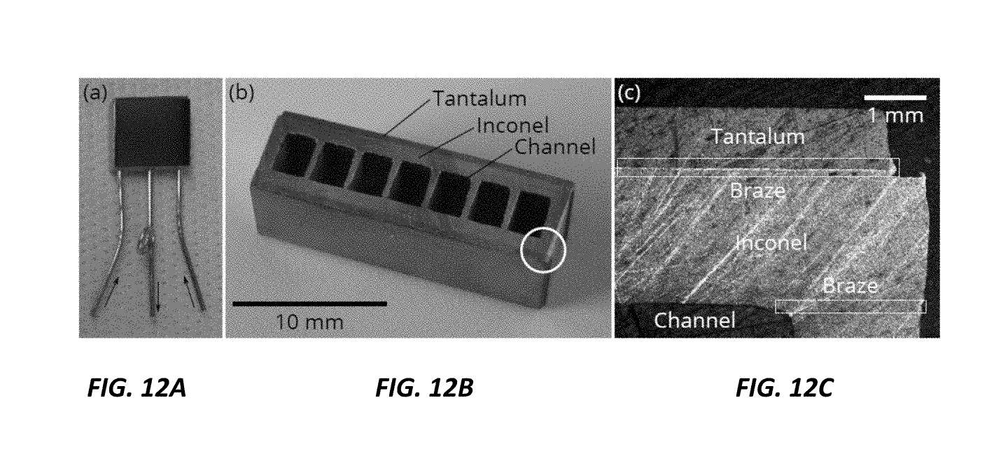

The brazing layer 130 can include a metal having a melting point lower than the melting points of the first metal of the combustor 110 and the second metal of the photonic crystal 120. During brazing, the brazing material can be melted to integrate the combustor 110 with the photonic crystal 120 without affecting the integrity of these two components. In another example, the brazing layer 130 can include a metal doped with a melting point depressant. For example, the brazing layer 130 can include nickel doped with silicon, boron, or phosphorous. More details about the brazing layer 130 and the brazing process are discussed below with reference to FIGS. 12A-12C.

The PV cell 140 can include any appropriate PV cell. For example, the PV cell 140 can include a low band gap PV cell to increase the absorption efficiency. In one example, the PV cell 140 includes a GaSb cell that has a band gap corresponding to a wavelength at about 1.7 μm. In another example, the PV cell 140 can include an InGaAs cell that has a band gap corresponding to a wavelength at about 2.0 μm. In yet another example, the PV cell 140 includes an InGaAsSb cell that has a band gap corresponding to a wavelength at about 2.3 μm. In each case, the photonic crystal 120 used in the device 100 can be engineered to have a cutoff wavelength matching the band gap of the PV cell 140.

Combustors

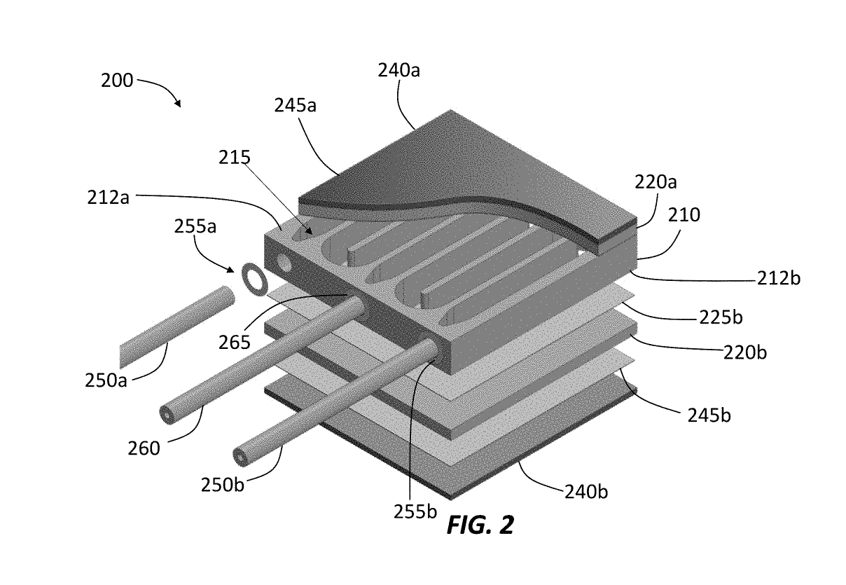

FIG. 2 shows a schematic of a combustor 200 that can be used in a TPV device to generate heat by burning fuel. The combustor 200 includes a metal substrate 210 defining a channel 215 to guide the fuel delivered by two input tubes 250a and 250b. The fuel, after combustion, is discharged from the combustor 200 via an output tube 260. The channel 215 can include two serpentine channels sharing the same output tube 260 (see, e.g., FIG. 1B). The inner wall of the channel 215 is coated with a catalyst (e.g., platinum on porous alumina). The channel 215 also has two external walls 212a and 212b, which are also the top and bottom surfaces of the substrate 210, respectively. As illustrated in FIG. 2, the channel 215 runs through the thickness of the substrate 210.

A first plate 220a (also referred to as a first cap 220a) is coupled to the first external wall 212a of the channel 215 via a first brazing layer (not shown), and a second plate 220b (also referred to as a second cap 220b) is coupled to the second external wall 212b of the channel 215 via a second brazing layer 225b. The first plate 220a and the second plate 220b substantially seal the channel 215. FIG. 2 also shows that a first photonic crystal 240a is coupled to the first plate 220a via a brazing layer 245a, and a second photonic crystal 240b is coupled to the second plate 220b via another brazing layer 245b. This brazing technique is also used to integrate the input tubes 250a and 250b and the output tube 260 to the substrate 210. For example, the input tubes 250a and 250b are integrated to the substrate 210 via brazing rings 255a and 255b, respectively, and the output tube 260 is integrated to the substrate 210 via a brazing ring 265.

In operation, the combustor 200 can react fuel (e.g., propane) and oxidizer (e.g., oxygen and/or air) to heat the photonic crystals 240a and 240b to about 900° C. or higher. The catalyst coated on the inner wall of the channel 215 can help maintain combustion reaction at the mesoscale. The planar serpentine channel 215 with catalyst-coated walls can provide sufficient interaction time for complete combustion of the fuel while fitting within external dimensions matched to those of available PV cells. The channel 215 can be dimensioned to provide sufficient length such that the residence time of the fuel can be greater than the time for the fuel to diffuse across the channel 215. In practice, the length can depend on the hydraulic (effective) diameter of the channel 215. For example, the channel 215 can have a length such that the residence time is at least two or three times greater than the diffusion time, where the residence time refers to the amount of time the fuel spends in the combustor, and the diffusion time refers to the amount of time the fuel takes to diffuse across the channel 215.

The combustor 200 can be suspended by the three tubes 250a/b and 260 to reduce conductive heat losses. For example, the combustor 200 in operation can be disposed in a chamber, and the three tubes 250a/b and 260 can support the combustor 200 surrounded by air or vacuum (i.e., without touching other solid surface with high heat conduction).

To improve temperature uniformity, a symmetric design is used in the combustor 200, where fuel is delivered via the two input tubes 250a and 250b from the ends of the channel 215 and combusted fuel is released via the output tube 260 disposed in the middle of the channel 215. In this configuration, the increased heat production near the input tubes 250a and 250b can compensate for the increased heat loss near the edges of the substrate 210. In one example, in the input tubes 250a and 250n, propane can be delivered via a fine capillary tube run inside an outer tube, and oxygen can be delivered via the annulus formed between the capillary and outer tube. This tube-in-tube configuration can prevent flashback and premature combustion in the input tubes 250a and 250b.

Inconel 600 (14-17% chromium, 6-10% iron, balance nickel) can be used for various components in the combustor 200, including the substrate 210, the two plates 220a and 220b, and the three tubes 250a/b and 260. Inconel has high-temperature stability in both oxidizing and vacuum environments, low cost, and high machinability. In addition, a metallic combustor made of Inconel is compatible with the metallic photonic crystals 240a and 240b (e.g., made of tantalum). A metallic combustor is also more robust against thermal and mechanical shock compared to silicon and ceramic combustors.

During manufacturing, the metal components (e.g., substrate 210 with the channel 215, plates 220a and 220b, tubes 250a/b and 260) can be fabricated by abrasive water jet cutting or machining from sheet stock. The holes for the tubes 250a/b and 260 can be machined to ensure a consistent gap (e.g., about 25 μm) between the tubes and the corresponding holes in the substrate 210 so that the brazing material can reliably flow by capillary action. In some cases, the center tube 260 can be bent into a loop to relieve stress arising from differing thermal expansion between input tubes 250a/b and the output tubes 260.

Braze preforms can be fabricated from foil by photochemical machining using dry film photoresist and ferric chloride etching solution. Preforms can be further sized to deliver a slight excess of braze alloy to the joint. In some cases, the braze alloy can include one or more melting point depressants, which can diffuse into the parent metal during the brazing cycle, thereby allowing the assembly to be reliably operated above the brazing temperature. For example, the brazing material (used in any of the brazing layers 225b, 245a/b, 255a/b, and 265) can include BNi-2 (e.g., from Lucas-Milhaupt), which includes 7% chromium, 3% boron, 4.5% silicon, 3.0% iron, and balance nickel. BNi-2 has a solidus temperature of about 971° C. and a liquidus temperature of about 999° C. This braze alloy can be subjected to a prolonged anneal above its liquidus temperature, during which the silicon and boron can diffuse out and the molten alloy undergoes isothermal solidification. Once the silicon and boron have diffused out, the remelt temperature can exceed 1400° C. The increase in the remelt temperature has several advantages. For example, it can allow the use of the same braze alloy for all brazing steps and avoid exposing the photonic crystals 240a and 240b to a higher temperature than otherwise used. The alloy also allows the brazing to be carried out in a low-cost furnace.

The brazing can be conducted in three steps. First, the tubes 250a/b and 260 can be brazed to the substrate 210 (and accordingly the channel 215). Second, the plates 220a and 220b can be brazed to seal the channel 215. Third, the photonic crystals 240a/b can be brazed to the plates 220a and 220b. Jigs can be used to hold the components in place for each of the steps. For the first and second brazing operations, the jigs can be machined from Inconel. For the third brazing operation, the jig can be machined from tantalum to avoid contamination of the photonic crystals 240a and 240b.

The brazing operations can be performed in a quartz tube furnace evacuated by a turbo molecular pump. High temperature and high vacuum can be used to shift the chemical equilibrium to favor the dissociation of surface oxides before the braze alloy melted. Flux and reactive atmospheres (e.g., hydrogen) can be avoided to prevent contamination of the photonic crystals 240a and 240b. After pump-down, the furnace can be ramped at about 10° C./minute, with one hour stops at 350° C. and 500° C. for degassing, to a final brazing temperature of about 1100° C. When the brazing temperature is reached, the furnace pressure can initially spike to about 5×10⁻⁵ Torr then reduce to about 3×10⁻⁶ Torr. The temperature can be held at about 1100° C. ° C. for two hours to ensure full diffusion before cooling to room temperature.

The next fabrication step can be the application of the catalyst, which can be applied as a washcoat. For example, the coating can be applied using a 10 wt % suspension of 5 wt % platinum on porous alumina (e.g., Sigma Aldrich 311324) in a 2 wt % solution of nitrocellulose in an organic solvent. The solution can be filled into the combustor 200 through the tubes (e.g., 250a/b) and then removed from the combustor 200 with compressed air, leaving a thin coating on the walls. Upon initial heating, the nitrocellulose can decompose without residue.

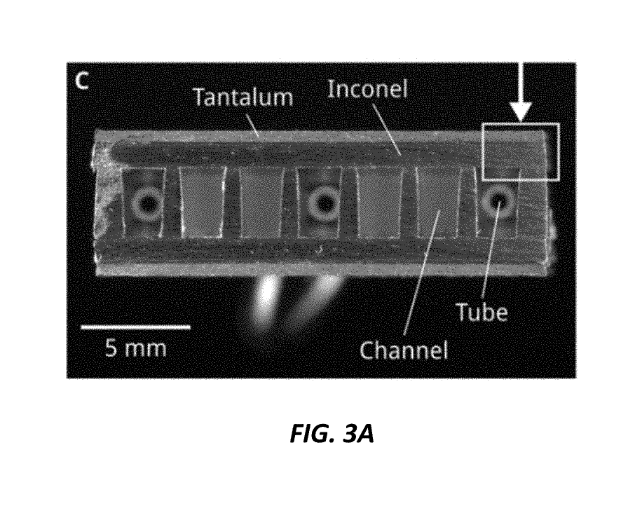

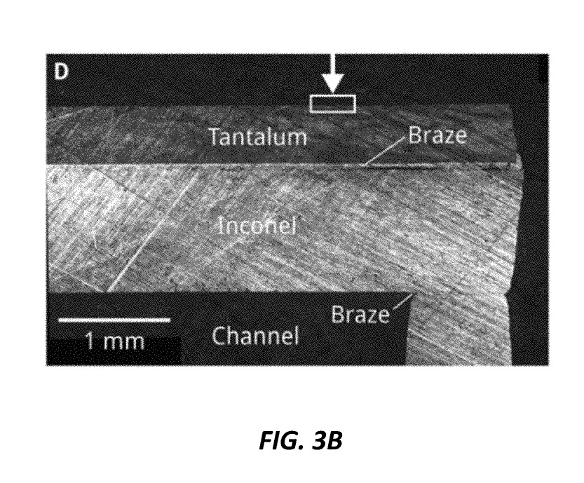

FIG. 3A is an optical micrograph of a cross section of the combustor 200 with unstructured tantalum substituted for the photonic crystals 240a and 240b. FIG. 3B is an optical micrograph of the corner (marked in white rectangular in FIG. 3A) of the combustor 200. As seen in FIGS. 3A and 3B, the Inconel plates substantially seal the channel, and the braze layer integrating the tantalum and the Inconel plates can be clearly seen.

Photonic Crystals

It can be desirable for the photonic crystal used in the TPV device to have the following properties: high temperature stability for a long operational lifetime, good optical performance, and a simple fabrication process capable of producing large area samples. Most of the available selective emitters (fabricated as 1D, 2D, and 3D photonic crystals, metamaterials, as well as from natural materials) typically only have one or two of these properties. For example, multilayer stacks and cermets emitters are easy to fabricate, but these heterogeneous platforms are subject to thermo-mechanical stresses and chemical reactions at material interfaces that are initiated at elevated temperatures. Homogeneous material platforms can also degrade at high temperature, because radius of curvature driven surface diffusion can shorten the lifetime of complex structures such as 3D photonic crystals.

FIG. 4A shows a schematic of a photonic crystal 400 that can be used in a TPV device and can address challenges in existing photonic crystals. The photonic crystal 400 includes a substrate 410 defining a two-dimensional (2D) array of cylindrical holes 420 (also referred to as cavities 420). The array of holes 420 has a pitch a (also referred to as a period a). Each cavity 420(1) has a radius r and a depth d. The cutoff wavelength of the photonic crystal 400 can be tuned by varying the radius r, period a, and depth d.

In operation, the photonic crystal 400 can enhance in-band emissivity (i.e., radiation between the band gap of the corresponding PV cell in a TPV device) through the introduction of cavity modes. The radius r, period a, and depth d can be chosen to match a specific cutoff wavelength. Without being bound by any particular theory or mode of operation, the approximate radius can be determined based on the desired cutoff wavelength (also referred to as the waveguide cutoff): r˜1.8412×λ_{c}/(2π), where λ_{c} is the cutoff wavelength. The effect of the depth d can be illustrated from a Q-matching point-of-view: to increase or maximize in-band emissivity, the cavity's absorptive Q and radiative Q can be equal. A higher material absorption (i.e., lower absorptive Q) can be matched if r increases and d decreases, as the radiative Q scales as (d/r)³.

The exact dimensions of the photonic crystal can be determined by nonlinear numerical optimization of both finite-difference time domain (FDTD) and rigorous coupled wave analysis (RCWA) simulations. The material properties of the substrate 410 can be taken into account using a Lorentz-Drude model fitted unstructured tantalum. The geometry can be bounded based on fabrication considerations. For example, the fabrication can use a space of 100 nm between cavities 420 and the maximum cavity depth can be about 5.0 μm. The figure of merit used in the optimization can include the spectral selectivity at a given operating temperature.

In one example, each cavity 420(1) can be filled with a dielectric material. In another example, a conformal dielectric layer can be deposited on the photonic crystal 400, including the top surface 415 of the substrate 410 and the inner wall 425 in each cavity 420(1). The dielectric material can be substantially transparent to the radiation emitted by the photonic crystal 400 (e.g., in visible and near infrared region). Dielectric materials that can be used herein include, for example, HfO₂, SiO₂, TiO₂, Al₂O₃, TiN, and other oxide ceramics.

As described above, tantalum can be used as the substrate 410 for the photonic crystal 400 due to its high melting point, low vapor pressure, advantageous low emissivity in the infrared, and ability to be etched. Sheet tantalum (e.g., from H. C. Starck) with a thickness of 0.5 mm can be cut into 50 mm wafers and polished to mirror finish on one side (e.g., from Cabot Microelectronics).

The photonic crystal 400 shown in FIG. 4A can address the challenges of large-area fabrication and integration, good optical performance, and high-temperature stability. Interference lithography and deep reactive ion etching can be used to fabricate the photonic crystal from tantalum. The lateral size of the photonic crystal 400 (e.g., diameter or side length) can be, for example, about 10 mm or greater (e.g., about 10 mm, about 20 mm, about 30 mm, about 40 mm, about 50 mm, about 60 mm, about 70 mm, about 80 mm, about 90 mm, or about 100 mm, or greater, including any values and sub ranges in between).

In practice, the photonic crystal 400 can be resistant to physical degradation because of its simple geometry. Tantalum also has a high melting point, a low vapor pressure, and limited atomic mobility. Additionally, the photonic crystal 400 can also be resistant to chemical degradation (e.g., formation of tantalum carbide) because of the conformal hafnium dioxide passivation layer.

FIG. 4B shows simulated spectral radiance normal to the surface of the photonic crystal shown in FIG. 4A at 1000° C. FIG. 4B also includes blackbody radiation (in dashed line) at the same temperature for comparison. As illustrated in FIG. 4B, the photonic crystal's emission spectrum can be engineered to primarily fall below a cutoff wavelength, i.e., near blackbody emission resulting from cavity resonances at the desired wavelengths and near zero emission elsewhere due the low loss of the substrate materials. The cutoff wavelength can be about 1.7 to about 2.3 μm. This cutoff photo energy can be matched to the bandgap of PV cells such that most of the emission from the photonic crystal can be in-band radiation (i.e., below the cutoff wavelength, shaded region in FIG. 4B) can accordingly can be converted to electricity.

Making a Photonic Crystal

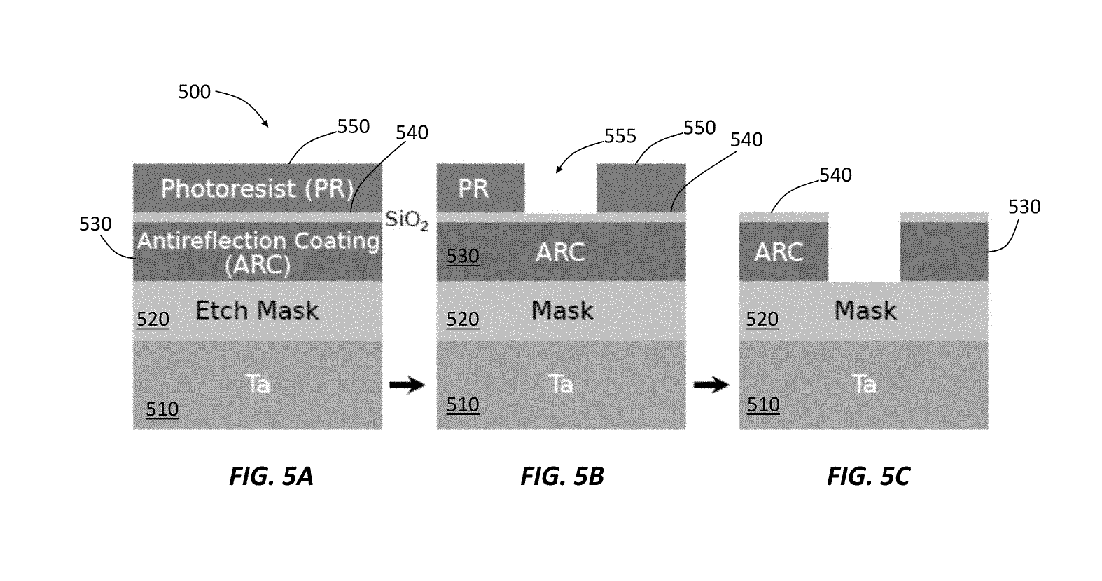

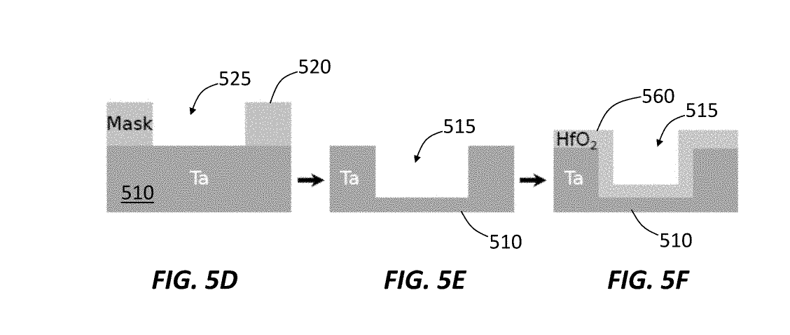

FIGS. 5A-5F illustrate a method 500 of fabricating a photonic crystal including an array of cavities coated with a conformal dielectric layer. The method 500 begins by deposition of an etch mask 520 (e.g., SiO₂, 100 nm thick) on a metal substrate 510 (e.g., tantalum) via, for example, plasma-enhanced chemical vapor deposition (PECVD), as shown in FIG. 5A. An anti-reflection coating (ARC) 530 is deposited on the etch mask 520 via, for example, spin coating. A protection layer 540 (e.g. SiO₂, 15 nm thick) is disposed on the ARC 530 via electron beam evaporation. A photoresist 550 (e.g., about 200 nm, from THMR-iNPS4, OHKA America) is coated on the protection layer 540 via spin coating. The ARC 530 can be used to prevent standing-wave induced vertically sinusoidal walls in the photoresist 550 resulting from reflections from the etch mask 520.

FIG. 5B shows that the photoresist 550 is patterned to create cavities 555 (only one cavity is shown). The patterning can be performed by, for example, interference lithography on a Mach-Zehnder setup with a 325 nm helium cadmium laser, which can produce a large periodic pattern with high uniformity. The period of the pattern a can be defined by the interference angle θ, as a=λ/2×sin θ. Two orthogonal exposures can be used to create a square array of circles, and the cavity diameter can be enlarged to the optimized value by isotropic plasma ashing.

In FIG. 5C, the pattern on the photo resist 550 is transfered through the stack of the photoresist 550, the protection layer 540, and the ARC 530 by reactive ion etching (ME, e.g., using Nexx Cirrus 150). In this process, the protection layer 540 protects the ARC 530 while ashing the photoresist 550. FIG. 5D shows that the pattern is further transferred to the mask 520 to create cavities 525. The substrate 510 is then etched by deep reactive ion etching (DRIE, e.g., Alcatel AMS 100) via a Bosch process using SF₆ and C₄F₈ as the etching and passivating gaseous species, as shown in FIG. 5E. This step creates cavities 615 in the substrate 610.

After the pattern transfer into the substrate 510, the residual passivation layer can be removed by oxygen plasma. The residual SiO₂ mask 520 can be removed by hydrofluoric acid. FIG. 5F shows that a conformal dielectric layer 560 (e.g., 20 nm conformal layer of HfO₂) is deposited onto the surface of the cavities 515 and the top surface of the substrate 510. The deposition can be performed by, for example, atomic layer deposition (ALD) at 250° C., using tetrakis dimethylamino hafnium (TDMAH) and water as precursors to prevent degradation of the surface at high temperatures.

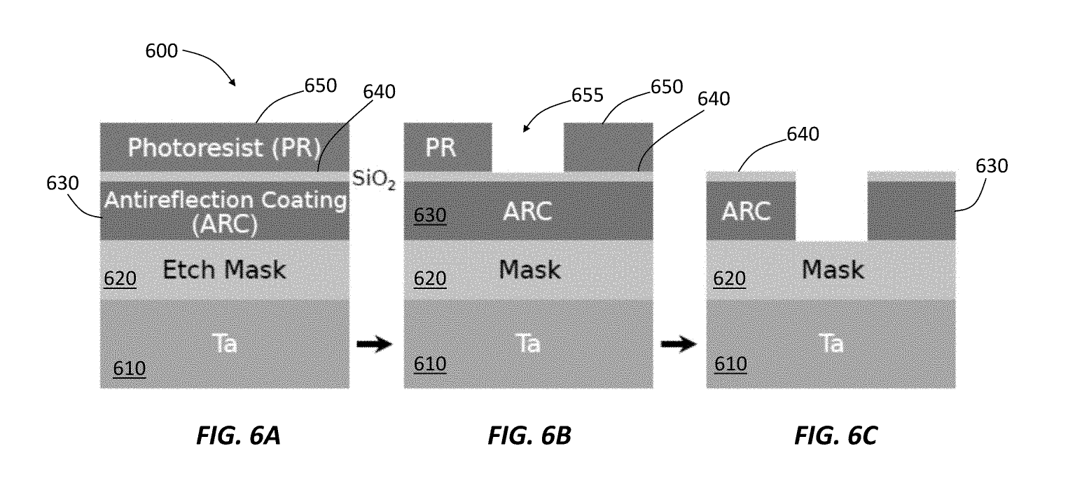

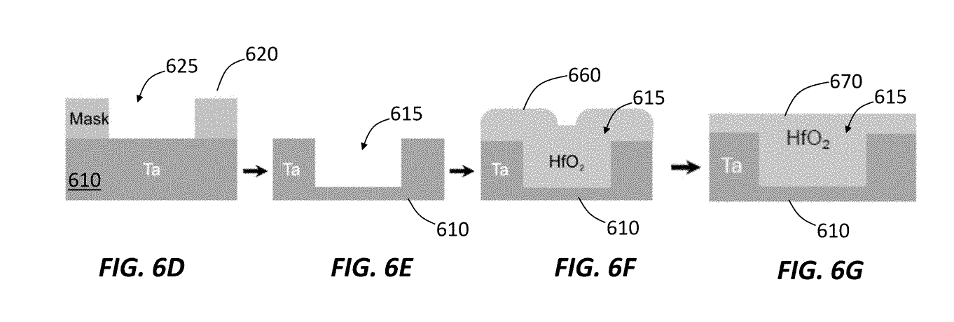

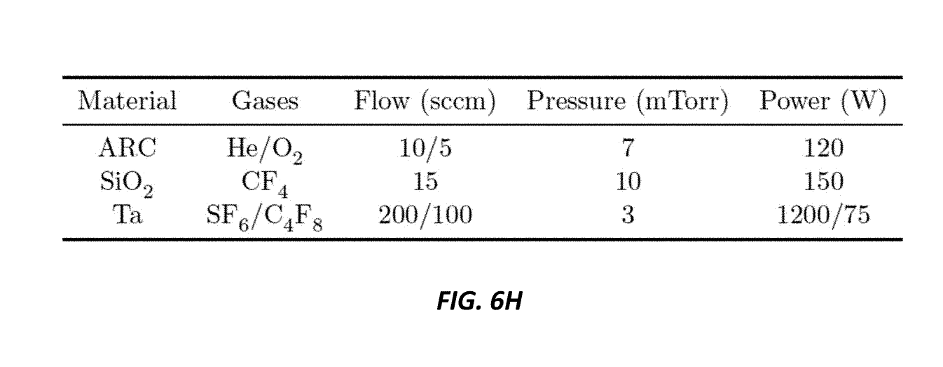

FIGS. 6A-6G illustrate a method 600 of fabricating a photonic crystal including an array of cavities defined in a metal substrate and filled with a dielectric material. As shown in FIG. 6A, the method 600 begins by deposition of an etch mask 620 on a metal substrate (e.g., tantalum) via, for example, plasma-enhanced chemical vapor deposition (PECVD). An anti-reflection coating (ARC) 630 is deposited on the etch mask 620 via, for example, spin coating. A protection layer 640 (e.g. SiO₂, 15 nm thick) is disposed on the ARC 630 via electron beam evaporation. A photoresist 650 (e.g., about 200 nm) is coated on the protection layer 640 via spin coating. The ARC 630 can be used to prevent standing-wave induced vertically sinusoidal walls in the photoresist 650 resulting from reflections from the etch mask 620.

FIG. 6B shows that the photoresist 650 is patterned to create cavities 655. The patterning can be performed by, for example, interference lithography on a Mach-Zehnder setup with a 325 nm helium cadmium laser, which can produce a large periodic pattern with high uniformity. The period of the pattern a can be defined by the interference angle θ, as a=Λ/2×sin θ. Two orthogonal exposures can be used to create a square array of circles, and the cavity diameter can be enlarged to the optimized value by isotropic plasma ashing.

In FIG. 6C, the pattern on the photo resist 650 is transfered through the stack of the photoresist 650, the protection layer 640, and the ARC 630 by reactive ion etching (ME). In this process, the protection layer 640 protects the ARC 630 while ashing the photoresist 650. FIG. 6D shows that the pattern is further transferred to the mask 620 to create cavities 625. The substrate 610 is then etched by deep reactive ion etching (DRIE) via a Bosch process using SF₆ and C₄F₈ as the etching and passivating gaseous species, as shown in FIG. 6E. This step creates cavities 615 in the substrate 610. FIG. 6H is a table showing one example of etching parameters that can be used in the method 600.

After the pattern transfer into the substrate 610, the residual passivation layer can be removed by oxygen plasma. The residual SiO₂ mask 620 can be removed by hydrofluoric acid. FIG. 6F shows that a dielectric materials 660 is deposited into the cavities 615 (e.g., using ALD), after which Argon sputtering is carried out to remove the thick top layer after ALD. The structure after the Ar sputtering is shown in FIG. 6G.

Performance of Filled and Unfilled Photonic Crystals

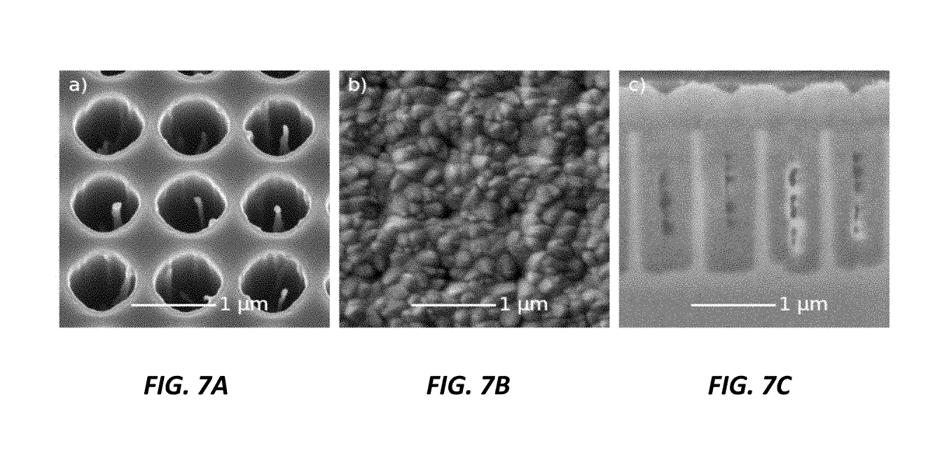

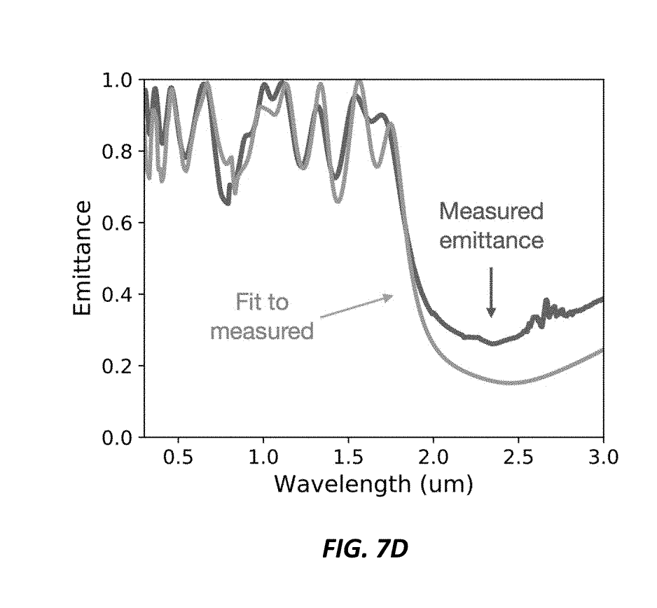

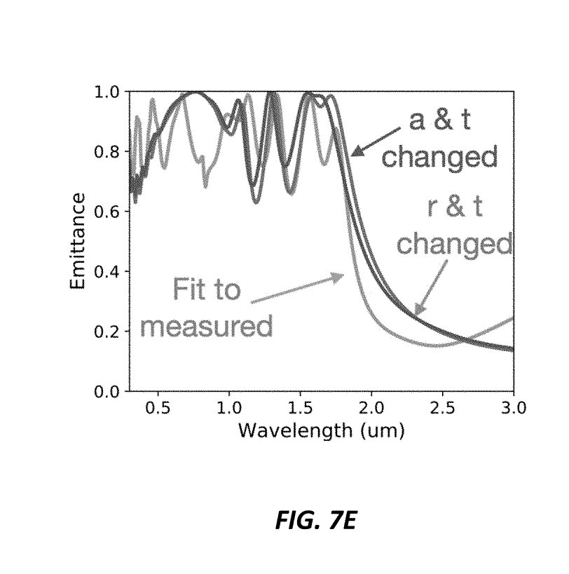

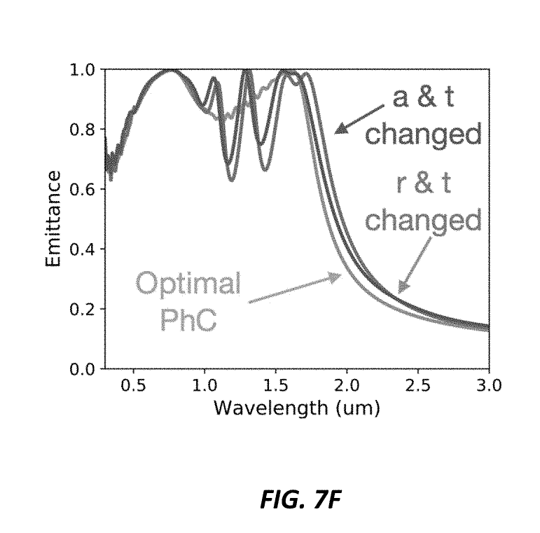

FIG. 7A is an SEM image of a photonic crystal before cavity filling with Hafnium dioxide. FIG. 7B is an SEM image of the photonic crystal after cavity filling. FIG. 7C is a cross section of the photonic crystal after filling. The photonic crystal in FIGS. 7A-7C has a period a of about 0.5 μm, a radius r of about 0.2 μm, and a cavity depth d of about 1.5 μm before filling. The filling of the holes is relatively uniform, as show in FIG. 7C.

FIGS. 7D-7F illustrate optimization of optical performance of the photonic crystal by adjusting geometrical dimensions of the photonic crystal. FIG. 7D shows measured emittance of a filled photonic crystal fitted by numerical optimization. FIG. 7E shows fitted emittance of the filled photonic crystal compared with simulated emittance of fabricated photonic crystal with: a) optimized cavity pitch a and thickness of the dielectric layer t, and b) optimized cavity radius r and the thickness of the dielectric layer t. The thickness of the dielectric layer t refers to the thickness of the portion of dielectric material on top of the metal substrate. FIG. 7F shows emittance of a photonic crystal with optimal filling of HfO₂ compared with simulated emittance with a) optimized cavity pitch a and thickness of the dielectric layer t, and b) optimized cavity radius r and the thickness of the dielectric layer t. FIGS. 7D-7F demonstrate that adjusting the dimensions of the photonic crystal, including the cavity pitch a, the radius r, and the thickness t, can improve the optical performance of the photonic crystal in a resulting TPV system.

The Hafnia-filled, two dimensional (2D) tantalum (Ta) photonic crystals (PhCs) described herein are promising emitters for high performance TPV systems because they allow efficient spectral tailoring of thermal radiation for a wide range of incidence angles. However, fabrication imperfections may exist during manufacturing (e.g., according to the method 600 illustrated in FIGS. 6A-6G). Focused ion beam (FIB) imaging and simulations can be employed to investigate the effects of these fabrication imperfections on the emittance of a fabricated hafnia-filled PhC and also to identify geometric features that can drive the overall PhC performance.

One factor that can affect the system efficiency is the ratio of in-band emissivity, which is convertible by the PV cell, relative to the total emissivity. One approach to improve the conversion efficiency is to use two-dimensional (2D) tantalum (Ta) photonic crystals (PhCs) to spectrally tailor the thermal radiation to the PV cell bandgap as described above. This approach can create a 4.3% fuel-to-electricity system efficiency using PhCs coated with a hafnia layer having a thickness of about 20 nm to about 40 nm as the passivation layer.

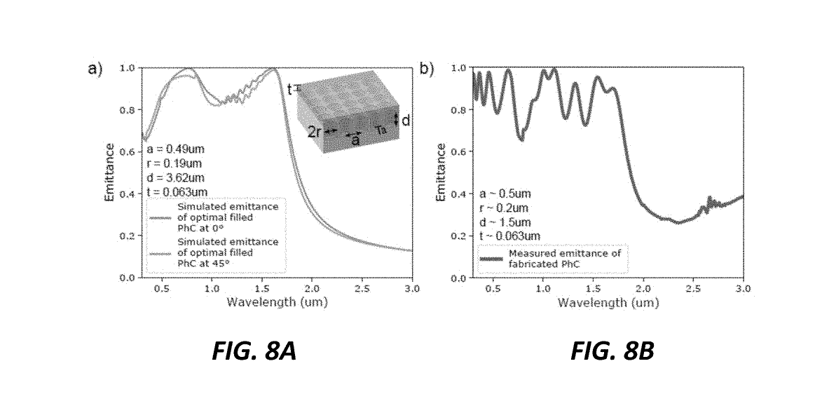

FIGS. 8A and 8B show calculated and measured emittance, respectively, of a photonic crystal including a 2D array of cavities defined in a tantalum substrate and filled with HfO₂. As shown in FIGS. 8A and 8B, filled PhCs have high in-band emissivity at a wide range of angles. Because most thermal radiation is off normal, an omnidirectional filled PhC can increase the total in-band radiated power by 55% at 1200° C. compared to an unfilled PhC. Like the coated PhC, a hafnia-filled PhC can also have high-temperature stability and resistance to chemical contamination.

However, filled PhCs may have fabrication imperfections, possibly because the cavity period a and radius r are reduced by approximately half (compared to the coated PhC) due to hafnia's high index of refraction (about 2). The smaller sizes can affect the fabrication in several ways, including the reduced cavity depths d (e.g., due to slower etch rates), more difficult cavity filling (e.g., due to higher cavity aspect ratios), and higher sensitivity to slight variations in PhC dimensions. The fabrication imperfections may cause the mismatch between the measured emittance and the simulated emittance, as shown in FIG. 8B.

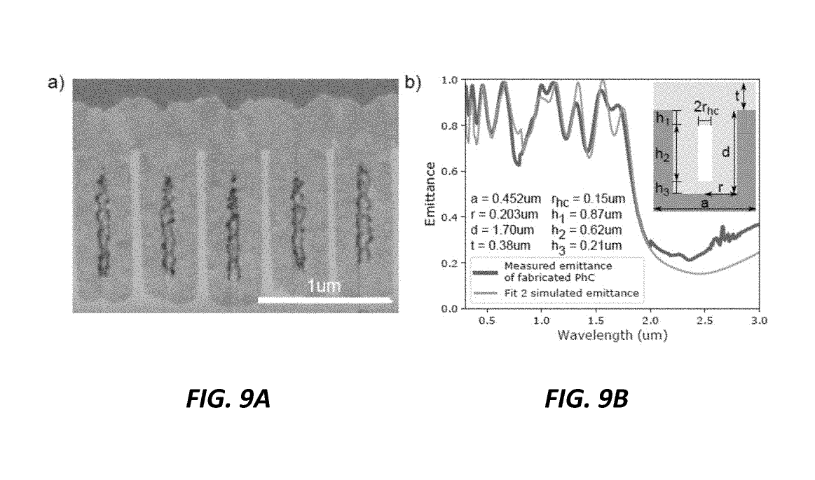

FIG. 9A is a focused ion beam (FIB) image of a fabricated PhC cavity cross section. FIG. 9B shows simulations of emittance fitted to the measured emittance using the FIB image in FIG. 9A as the basis for the geometric model for the fitting. The FIB image in FIG. 9A shows that the cavity filling is incomplete and there is a thick layer of hafnia covering the cavity. Based on this observation, a geometric model was constructed to include a hollow core and a thick top hafnia layer. In the simulation, the hollow core can be approximated as a cylinder centered at the cavity center, and the hafnia layer can be approximated as a simple slab (see, inset in FIG. 9B). Secondary geometric effects such as scalloping of the top surface and the precise shape of the hollow core can be neglected.

The above model can be sufficient to capture the major features in the measured emittance spectrum: the position of the resonance peaks, cutoff, and shape of the long wavelength emittance, as shown in FIG. 9B. The dimensions from the fit are reasonably close to those measured from the FIB. According to simulation, the volume of hollow core can be about 21% that of the cavity. Also, the period a is about 40 nm shorter than that of the PhC used in calculation. Deviations of the fitting from the measured emittance may be attributed to secondary effects such as scalloping of the hafnia layer, variations in cavity size across the sample, and assumptions about hafnia optical parameters.

Based on the fitting shown in FIGS. 9A and 9B, geometrical parameters of the photonic crystal can be investigated to find out which one(s) can affect the emittance. In this investigation, a single parameter can be varied at a time while keeping all else equal. The figure of merit (FOM) in the investigation can include the ratio of the in band power to total radiated power, normalized to that of the optimal PhC, at 1200° C. The investigation shows that changing a single variable usually does not significantly affect the emittance. For example, increasing the cavity depth changes little the resulting emittance. In another example, reducing the thickness t of the top hafnia layer to 63 nm can increase the in-band emissivity from about 0.5 μm to about 1 μm but also shifts the cutoff towards a longer wavelength, which effectively increases the out-of-band emissivity.

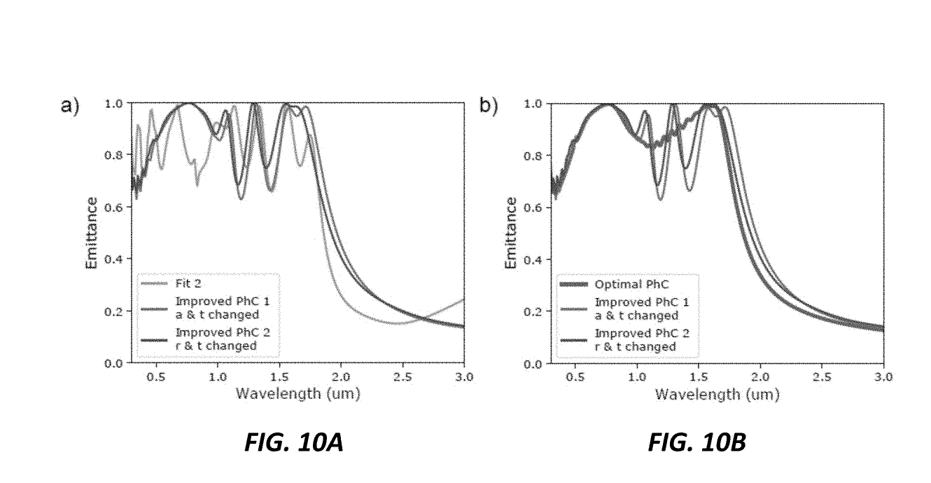

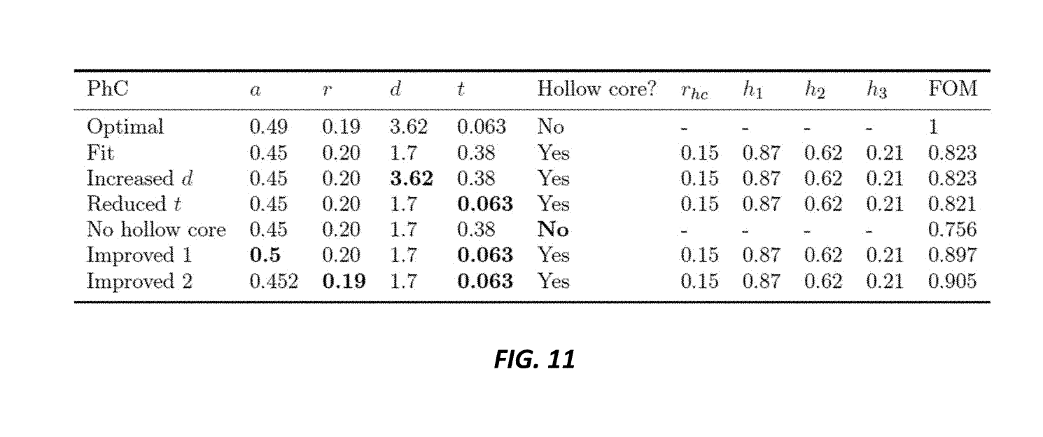

Instead, it is simultaneously changing both t and either a or r that can more dramatically improve the emittance. FIGS. 10A and 10B show calculated emittances of two PhCs with improved dimensions. FIG. 11 is a table listing dimensions (in μm) of PhCs used in the simulation shown in FIGS. 10A and 10B, as well as their figures of merit (FOM) calculated at 1200° C. for λ_{cutoff}=1.8 μm. Parameters in bold are parameters changed from the fit.

As shown in FIG. 11, the thickness t is changed to the optimal t, and the period a can be changed to 0.5 μm or the radius r can be changed to the optimal r. Compared to Fit 2 (see FIG. 10A), both improved PhCs have improved in-band emissivity from about 0.3 1.0 μm to 1.0 μm and 1.5 μm to the cutoff. The out-of-band emissivity from the cutoff to 2.7 μm becomes higher but improves from 2.7 μm to 3.0 μm.

The thickness t impacts the emittance both above and below the cutoff wavelength. Above the cutoff, the top layer can create Fabry-Perot resonances whose peak locations can be estimated by considering reflection. Tuning t to roughly below λ_{cutoff}/(4n) can prevent destructive interference of reflected waves near λ_{cutoff} and eliminate high emittance above the cutoff. Below the cutoff, the higher emittance is likely due to the hybridization of Fabry-Perot modes and cavity resonances.

As FIG. 10B shows, the emittances of the improved PhC are actually better match that of the optimal PhC. This suggests that fabricating the a, r, and t to be within about 10 nm of the optical values can make a PhC robust against a hollow core. The depth d appears to be less crucial compared to a, r, or t.

FIGS. 8A-10B together indicate that the mismatch between the measured and the calculated emittance can be attributed to the presence of a hollow core, a thick hafnia layer (t), and the deviation of the period a from the optimal value. To improve the emittance, it can be more helpful to precisely fabricate the cavity period a and radius r, and to reduce the thickness t of the hafnia layer than to prevent the formation of the hollow core. With techniques such as stepper-based lithography and argon sputtering, it can be feasible to achieve about 90% of the spectral selectivity of the optimally filled PhC.

Brazing Technologies for System Integration

Manufacturing a stable TPV hot side has been challenging because of the high temperatures and the thermo-mechanical stresses arising from thermal expansion mismatch between the combustor and photonic crystal. Combustors (for TPV and other applications) have been fabricated from silicon by MEMS techniques, from laminated metal layers by diffusion bonding, and from welded metal components. These methods are usually difficult and unreliable. For example, a multilayer silicon/silicon dioxide stack (1D photonic crystal) can be directly deposited onto a MEMS combustor. Alternatively, a metallic photonic crystal may be welded to a metallic combustor. However, the optical performance offered by the multilayer stack and the thermal contact offered by welding were not satisfactory.

In systems and apparatus described herein, brazing technology is used to couple the photonic crystal to the combustor (as well as to couple individual components within the combustor, see, e.g., FIG. 2). In one example, the brazing technology can use a metal (or a metal alloy) as the brazing material. In another example, diffusion brazing can be used for system integration, in which case the brazing material includes a melting point depressant, as described below.

In a TPV device, diffusion brazing can be used to both fabricate the combustor and integrate the tantalum photonic crystal. The melting point depressants can increase the remelt temperature, allowing the resulting assembly to be reliably operated above the original brazing temperature. For example, a TPV device like the device 200 shown in FIG. 2 can be integrated using BNi-2 (Lucas-Milhaupt) as the brazing alloy, which has a solidus temperature of about 971° C. and a liquidus temperature of about 999° C. The alloy has the following composition: 7% chromium, 3% boron, 4.5% silicon, 3.0% iron, and balance nickel. During integration, the braze alloy is subjected to a prolonged anneal above its liquidus, during which the silicon and boron diffuse out and the molten alloy undergoes isothermal solidification. If the silicon and boron are completely removed, the remelt temperature can exceed 1400° C. The increase in remelt temperature enables one to use the same braze alloy for multiple brazing steps, to avoid exposing the photonic crystal to a higher temperature than absolutely required, and to perform the brazing in a low-cost furnace limited to 1200° C. even through the target operating temperature is 1000-1200° C.

In a TPV system, it is usually a concern that significant stresses, and therefore deflections, can occur in the final brazed assembly owing to the differential thermal expansion between Inconel and tantalum. Inconel is used for the combustor for its high-temperature oxidation resistance, low cost, and machinability; tantalum is used for the photonic crystal for its low vapor pressure, low optical loss, and etchability. To reduce or prevent deflection, a symmetric design like the one shown in FIG. 2 can be used. In addition, long spans can be reduced or eliminated by brazing each external channel wall to both the top and bottom Inconel caps, also illustrated in FIG. 2.

FIG. 12A is a photo of a completed hot side in a TPV device with a diffraction pattern visible on the photonic crystal. The arrows indicate the direction of fuel (and oxidizer) flow. FIG. 12B shows the cross section of the TPV device shown in FIG. 12A with the channels visible. FIG. 12C is a micrograph of the indicated corner of the hot side assembly with the tantalum-Inconel braze joint visible and the Inconel-Inconel braze indicated.

The combustor channels are similar to those shown in FIG. 2 and fabricated by abrasive water jet cutting from Inconel sheet stock. The holes for the tubes were reamed over-sized to ensure a consistent 25 μm gap between the tubes and hole so that the brazing material can reliably flow by capillary action. FIG. 12A shows that the central tube was bent into a loop to relieve stress arising from differing thermal expansion between inlet and outlet tubes.

The braze preforms used in FIGS. 12A-12C were fabricated from foil by photochemical machining using dry film photoresist and ferric chloride etching solution. Preforms can also be dimensioned to deliver a slight excess of braze alloy to the joint. Brazing was conducted in three steps: tubes were brazed to the channels, caps were brazed to seal the channels, and the photonic crystals were brazed to the completed combustor. Jigs were used to hold components in place for each of the steps. The jigs used for the first and second brazing operations were machined from Inconel. The one for the final brazing operation was machined from tantalum to avoid contamination of the photonic crystal, as some outgasing of the Inconel was observed.

The brazing was performed a quartz tube furnace evacuated by a turbo-molecular pump. The high temperature and high vacuum can shift the chemical equilibrium to favor the dissociation of surface oxides before the braze alloy melted. Flux and reactive atmospheres (e.g. hydrogen) were avoided to prevent contamination of the photonic crystal.

After pump-down, the furnace was ramped at 10° C./minute, with one hour stops at 350° C. and 500° C. for degassing, to a final brazing temperature of 1100° C. When the brazing temperature was reached, furnace pressure would initially spike to about 5-10⁻⁵ Torr, then reduce to 3-10⁻⁶ Torr. The temperature was held at 1100° C. for two hours to ensure full diffusion before returning to room temperature.

During process development, ten hot side assemblies were fabricated with bare tantalum substituted for the photonic crystal. They experienced high fabrication yield as defined by visual inspection and helium leak detection. A cross section of one is shown in FIGS. 12B and 12C. One combustor without a photonic crystal was operated for one week without failure or visual damage. A photonic crystal instead of bare tantalum was also integrated to a combustor. The finished assembly is shown in FIG. 12A. Reflectance measurements of the photonic crystal before and after brazing confirmed no degradation of optical properties of the photonic crystal.

There experiments demonstrate that diffusion brazing can be employed to integrate an Inconel combustor with a tantalum photonic crystal to serve as the hot side of a millimeter-scale TPV generator. In diffusion brazing, fast-diffusing elements contained in the alloy can diffuse out of the joint during heating, thus increasing the remelt temperature of the braze above the original brazing temperature. This approach can integrate the combustor and photonic crystal in a fast, simple, and reliable manner.

Integrated TPV Devices with Vacuum Packaging

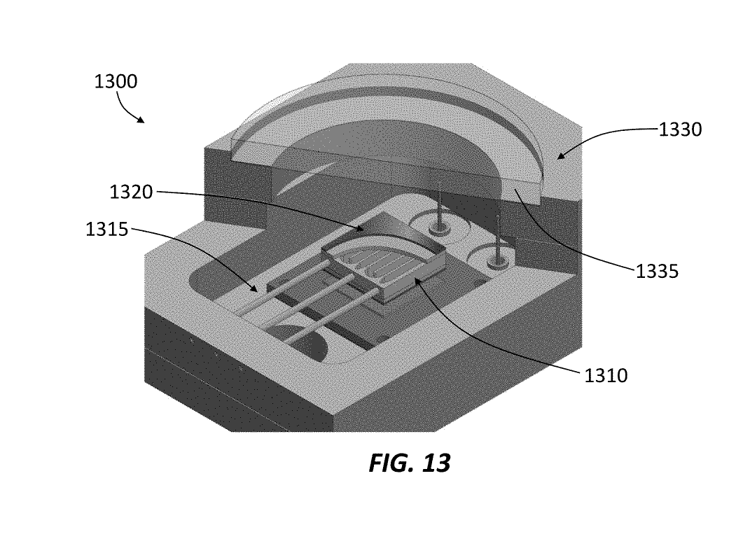

FIG. 13 shows a schematic of a TPV device 1300 including a vacuum chamber 1330 that encloses a combustor 1310 integrated with a photonic crystal 1320. A second photonic crystal (not illustrated in FIG. 13) can be disposed on the opposite side of the combustor 1310. The combustor 1310 is fueled via three tubes 1315 extending out of the vacuum chamber 1310. The combustor 1310 and the photonic crystal 1320 can be substantially similar to the corresponding components in the combustor 200 shown in FIG. 2. The vacuum chamber 1330 includes a window 1335 that is substantially transparent to the radiation emitted by the photonic crystal 1320. One or more PV cells (not shown in FIG. 13) can be disposed outside the vacuum chamber 1310 to receive and convert the radiation into electricity. The vacuum environment surrounding the combustor 1310 and the photonic crystal 1320 can reduce heat loss due to conduction and can also protect these components from oxidization. In operation, the pressure in the vacuum chamber 1310 can be substantially equal to or less than 5×10⁻⁵ Torr (e.g., about 5×10⁻⁵ Torr, about 10⁻⁵ Torr, about 5×10⁻⁶ Torr, about 10⁻⁶ Torr, or less, including any values and sub ranges in between).

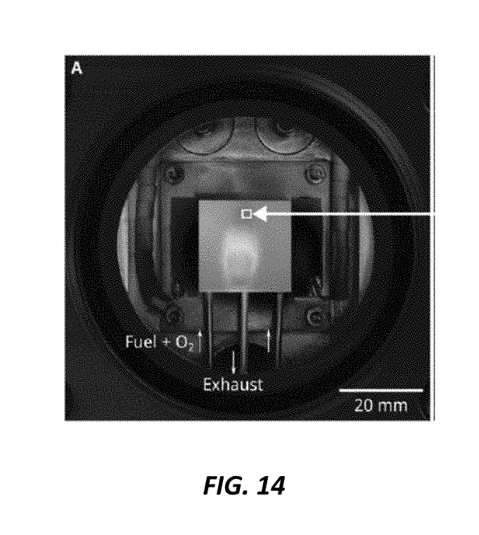

FIG. 14 is a photograph of the device 1300 shown in FIG. 13 during operation, where a diffraction pattern is visible on the photonic crystal from the ambient light.

In operation, pure oxygen can be used in the combustion reaction to emulate exhaust recuperation, which is typically included in a portable, air-breathing system. Propane and oxygen are delivered into the combustor 1310 through the inlet tubes and then flow through an internal serpentine channel, where they can react on the catalyst-coated walls (e.g., 5% platinum on porous alumina). The combusted fuel exits though the outlet tube. Heat can be conducted through the channel walls to the photonic crystals 1320 bonded to the top and bottom surfaces of the combustor 1310.

The photonic crystal 1320 emits spectrally-confined thermal radiation that matches the band gap of an InGaAs cell (e.g., band gap at around 2.0 μm), which can be mounted below the assembly 1300. The vacuum in the vacuum chamber 1330 can suppress convection and prevent the degradation of the photonic crystal 1320 by reaction with air.

To ignite the combustion, the combustor 1310 can be heated to approximately 400° C. with a halogen lamp through the window 1335. Above that temperature, the propane kinetics over the catalyst can be sufficient for auto thermal operation, and the halogen lamp can be shut off. In one operation, propane flows, corresponding to a total latent heat input of about 20 W to about 100 W, were increased in small increments while maintaining an oxygen flow of about 7.5 times that of propane (in an equivalence ratio of φ=1.5), and the steady-state electrical output at the maximum power point was measured.

The device 1300 was characterized with and without the photonic crystal 1320. For the operation without the photonic crystal 1320, the bare Inconel surface was oxidized by air until it was visibly black (emissivity ϵ of about 0.8) and it was then used as the emitter.

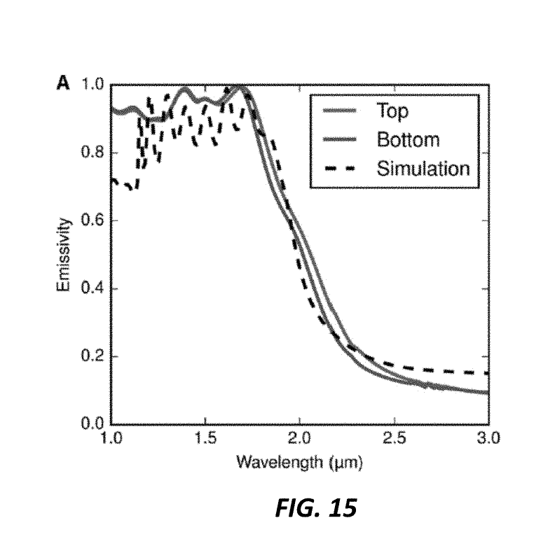

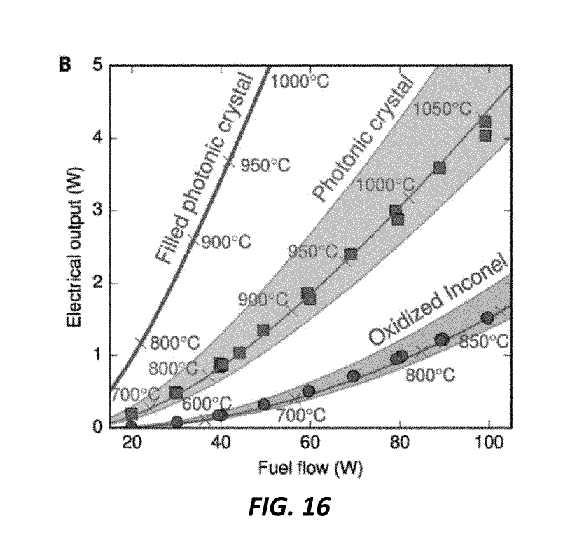

FIG. 15 shows measured and simulated emissivity of the photonic crystal 1320 in the device 1300 at room temperature and at the normal incidence. FIG. 16 shows measured and simulated electrical power output as a function of fuel flow of the device 1300. The electrical measurements shown in FIG. 16 are scaled for a full set of cells. A 4.3% fuel-to-electricity conversion efficiency was measured with the photonic crystal emitter and a 1.5% efficiency was measured with the oxidized Inconel emitter, for a fuel input of 100 W.

The points in FIG.16 are the experimental results and the lines and shaded bands are the simulation results, with the bands indicating a range of uncertain parameters. The simulated temperatures are indicated. Note that the filled photonic crystal (left line) has an electrical power output of 12.6 W at 100 W of fuel flow (not shown).

The TPV device 1300 can be modeled with a custom heat transfer code incorporating the radiation from the front and back emitters 1320 and the edges of the combustor 1310, the conduction through the support tubes 1315, with the heat carried out by the hot exhaust gases. The hemispherically averaged emissivity for the photonic crystal structure 1320 was computed using the Fourier modal method, in which the optical dispersion was captured with a Lorentz-Drude model fitted to unstructured tantalum. The simulated and measured normal incidence emissivities, plotted in FIG. 15, agree well.

Ray optics can be used to accurately incorporate multiple scattering effects between the emitter 1320 and the PV cell, assuming purely diffuse emission and reflection. The PV cell was modeled using a single diode equivalent circuit methodology. The combustor temperature, which is assumed to be uniform, was solved self-consistently. The simulated electrical power output and temperatures are shown in FIG. 16, where the shaded regions indicate the possible ranges of the experimental parameters, primarily the emissivity of the edges of the combustor.

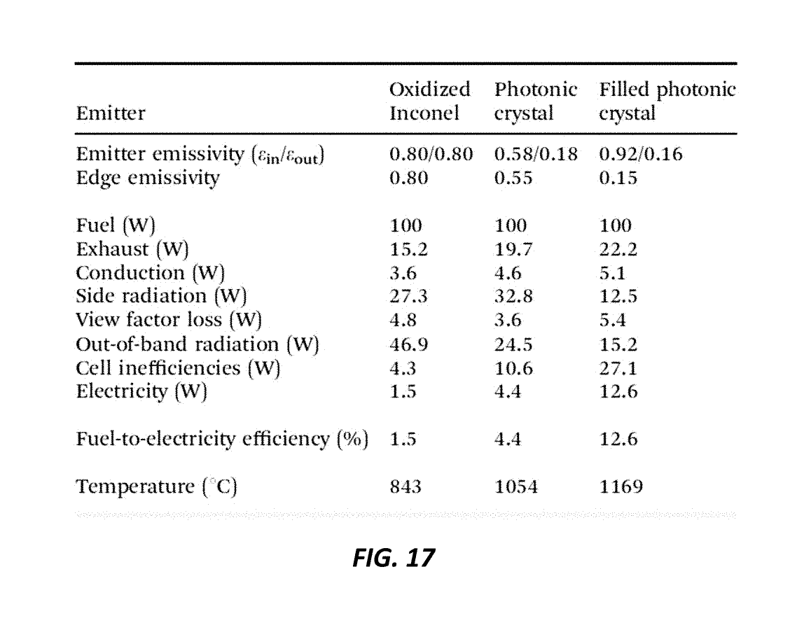

The above model can be used to study the heat flows within the TPV device 1300 with the photonic crystal 1320 and oxidized Inconel emitters. FIG. 17 is a table listing parameters used in this study. The hemispherically averaged in-band and out-of-band emissivities of the emitters, edge emissivity, power distribution, efficiency, and temperature are listed.

FIG. 17 shows that the in-band radiation increased nearly three times in the case of the photonic crystal even though its hemispherically-averaged and wavelength-averaged in-band emissivity was lower (ϵ=0.59 compared to ϵ=0.8). Because the photonic crystal suppressed the out-of-band radiation, the temperature increased by approximately 200° C., resulting in increased thermal radiation. From a practical point of view, the low out-of-band emissivity allows for a simpler system design without the need for photon recycling via a cold side filter placed between the emitter and PV cell. This can be challenging because of the wide range of angles and wavelengths that to be filtered with high selectivity and low loss. Moreover, because of the photonic crystal's high in-band emissivity, electricity generation can compete favorably with other heat loss mechanisms and a readily achievable emitter temperature of 1000° C. can provide greater than 500 mW cm⁻² of cell area output. These factors can be helpful in portable systems, as the low out-of-band emissivity can minimize the waste heat generated by the PV cell, and thus the heat sink size, and the high in-band emissivity can minimize the active area used for a specified electrical output as well as increasing efficiency.

Two approaches can be employed to further increase the conversion efficiency. The first approach is to reduce emissivity at the edges of the combustor. The edges are not only a portion of the total surface area but also radiate a disproportional amount when the photonic crystal suppresses the out-of-band radiation. Reducing the emissivity of the edges (e.g., from ϵ=0.55 to ϵ=0.15) can decrease the amount of fuel flow to achieve a given temperature. In this case, a fuel-to-electricity efficiency of about 7.6% at 100 W of fuel input can be achieved.

The second approach to increase the conversion efficiency is to increase the in-band emissivity of the photonic crystal, which can proportionally decrease the heat loss from the combustor edges and other combustor heat loss mechanisms. Although at a normal incidence the photonic crystal has near blackbody in-band emissivity, the wavelength-averaged in-band emissivity is about 0.59 when averaged over all of the angles. Filling the cavities with a dielectric material (e.g., hafnium dioxide) can increase the hemispherical in-band emissivity via several mechanisms. First, the physical and optical dimensions of the cavity are decoupled, allowing one to decrease the period and move the onset of diffraction well below the wavelength range of interest, even at oblique angles. Second, the optical density of states is increased and additional resonant peaks can be created, thereby further increasing the in-band emission.

However, filling the cavities may slightly increase the out-of-band emissivity because the dielectric material can increase the admittance of the cavities (approximated as waveguides) and hence the overall admittance of the effective medium (approximated as an area-weighted average between the flat surface and the cavity). Nevertheless, the simulations indicate that the resulting filled photonic crystal has omnidirectional thermal emission with an in-band emissivity of ϵ=0.92 while still having a low out-of-band emissivity of ϵ=0.16. The higher in-band emissivity results in a larger electrical output for a given temperature. In this case, a fuel-to-electricity efficiency of 12.6% at 100 W of fuel input can be achieved. This efficiency is several times higher than that of the heat-to-electricity conversion methods that have been previously reported.

FIGS. 13-17 together demonstrate that this high energy density, multi-fuel powered, compact generator can free portable electronics, robots, and small drones from the constraints of bulky power sources. One performance milestone can be achieved by improving the PV cell performance. State-of-the-art silicon solar PV cells operate at 85% of the Shockley-Queisser limit; on the other hand, state-of-the-art TPV cells only operate at ˜50% of their thermodynamic limit because of non-radiative recombination mechanisms, series resistance, and non-ideal quantum efficiencies. In other words, significant performance improvements are possible by following a similar research pathway, although low-bandgap semiconductors present a unique set of challenges compared to silicon. Another milestone can be achieved by improving the optical performance. Indeed, while the filled photonic crystal can achieve about 70% of the performance of an ideal (step function) emitter, as defined by the conversion of fuel to in-band radiation, a simple cold-side filter can increase this figure by further reducing the effective out-of-band emissivity near the cutoff. Further improvements can be made, for example, with a tandem PV-thermoelectric device to recover the out-of-band radiation, or with a thermoelectric device to recover the exhaust heat.

Integrated TPV Device Operating with Air Oxidizer

In TPV devices described herein, oxygen is usually used as the oxidizer for combustion. For a fully-integrated portable generator, it can be helpful to operate with air oxidizer, thereby freeing the device from oxygen sources that might be burdensome.

FIG. 18A shows a top view of a combustor 1800 operating with air oxidizer and FIG. 18B shows a cross sectional view of the combustor 1800. The combustor 1800 includes a substrate 1810 defining two layers of channels 1820a and 1820b (see FIG. 18B). Each layer 1820a/b includes a corresponding array of parallel channels 1815a/b. The combustor 1800 also includes an inlet tube 1812a to deliver fuel and oxidizer (i.e., air) and an outlet tube 1812b to release exhaust.

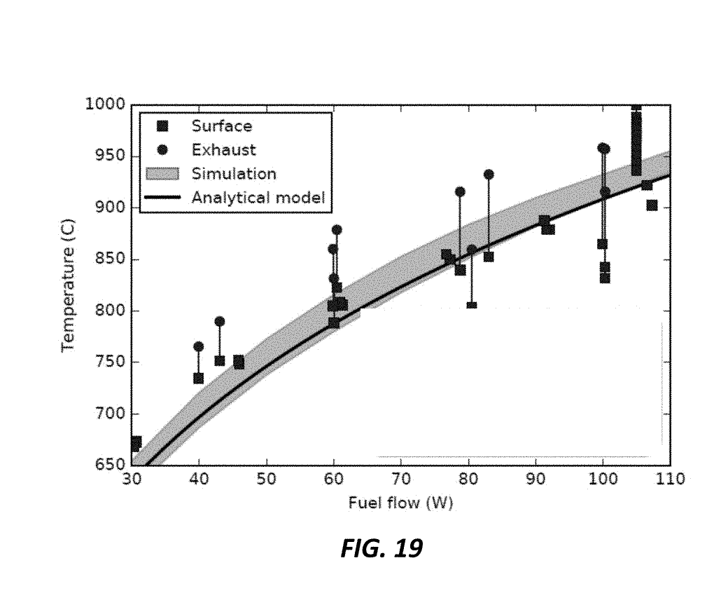

FIG. 19 shows simulated and measured operating temperature for the propane-air combustor 1800 as a function of fuel flow (calculated from the lower heating value). The combustor 1800 catalytically reacts propane with air to bring the photonic crystal emitter to incandescence. In one example, the combustor 1800 includes a 20×20 mm Inconel slab 1810 with two internal layers 1820a/b of catalyst-loaded channels 1815a/b. Propane and air react in the channels 1815a/b and the resulting heat is conducted through the channel walls to the photonic crystal emitters on the top and bottom surfaces. The device can be fabricated by diffusion brazing stacked layers as described herein. A two layer design can attain sufficiently long residence time and sufficiently short diffusion time to react 100 W of propane flow with air.

The combustor 1800 was also tested in the vacuum chamber. A thermocouple was spot welded to the surface to measure temperature and another thermocouple was inserted into the exhaust tube 1812b during some experiments to measure exhaust gas temperature. The combustor 1800 was ignited by bubbling the air through methanol, which reacted at room temperature over platinum, until heated to around 300° C., at which point propane-air operation was possible and the methanol bubbler was bypassed. Exhaust and surface temperatures for a range of propane flows are also shown in FIG. 19.

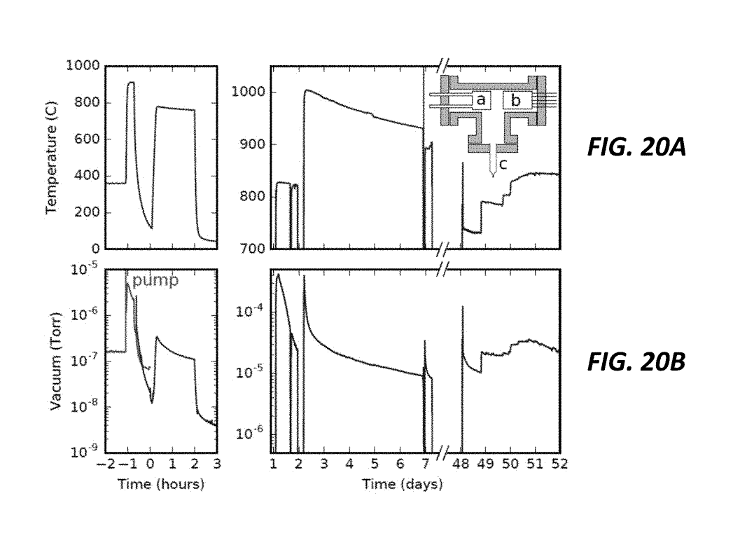

FIGS. 20A and 20B show measured temperature and vacuum, respectively, during a 50+ day experiment, with time measured relative to pinch-off (t=0). The inset shows the measurement setup including a combustor and an ion gauge disposed in a vacuum chamber with a copper pinch-off.

In order to prevent degradation of the photonic crystal emitter and to suppress convective losses, vacuum packaging can be used. To test the feasibility of vacuum packaging, a combustor and hot filament ion gauge were assembled in a Coflat (CF) tee, as shown in the inset of FIG. 20A. A zirconium based getter (Saes) was also placed in the chamber. A soft copper tube connected the test chamber to a turbo-molecular pump and residual gas analyzer. With the turbo-molecular pump running, the chamber was heated to 350° C. to degas and to activate the getter. In addition, the burner was ignited and the ion gauge was electrically heated. At the beginning of the bakeout, water vapor dominated; at the end, hydrogen and carbon monoxide dominated. The hydrogen was determined to be permeating through the walls of the combustor by injecting pulses of deuterium into the combustion reaction and observing the isotope ratio in the vacuum chamber. At the end of the bakeout, the copper tube was pinched off with a hydraulic crimper, isolating the vacuum chamber from the pump. Temperature and vacuum near pinch-off are shown in FIGS. 20A and 20B, respectively.

After pinch-off the combustor was run for six days without degradation of the vacuum. In fact, an improvement in vacuum was observed because the getter continued to act as an internal pump. The apparatus was left for nearly 40 days, during which the vacuum level was about 10⁻⁸ Torr. The combustor was successfully reignited and run without vacuum degradation, and stepped through several fuel flows.

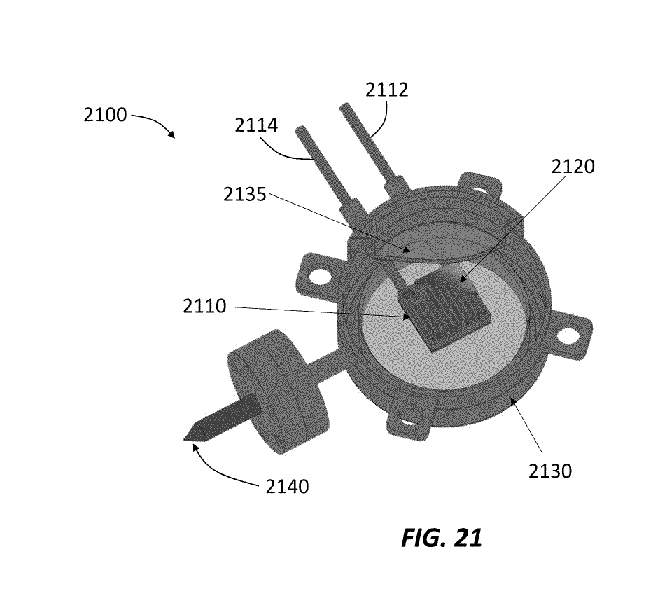

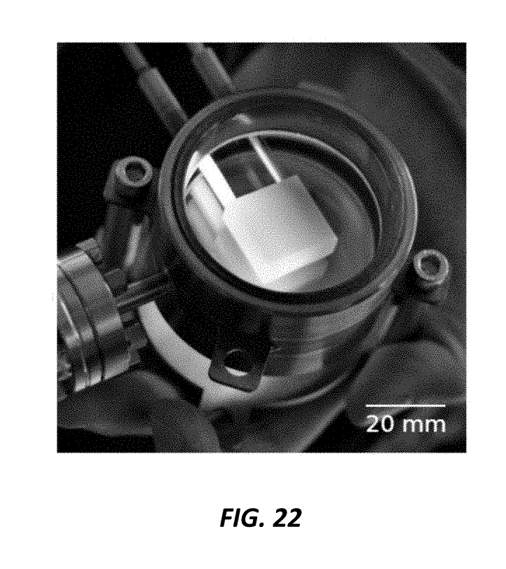

FIG. 21 shows a schematic of a TPV device 2100 operating with air oxidizer. FIG. 22 is a photo of the device 2100 shown in FIG. 21. The device 2100 includes a combustor 2110 integrated with a photonic crystal 2120. The combustor 2110 has an inlet tube 2112 to deliver fuel (e.g., propane) and air to the combustor 2110 and an exhaust tube 2114 to discharge exhaust. The assembly of the combustor 2110 and the photonic crystal 2120 is disposed in a vacuum chamber 2130 having a window 2135 for one or more PV cells (not shown) to receive radiation from the photonic crystal 2120. The device 2100 also includes a pinch-off 2140 to seal the vacuum chamber 2130 upon being pinched off. The window 2135 can be made from sapphire. Although vacuum level could not be directly measured, no discoloration of the combustor 2110 or photonic crystal 2120 (e.g., indication of oxidation) was observed.

Methods of TPV Energy Conversion Using Integrated TPV Devices

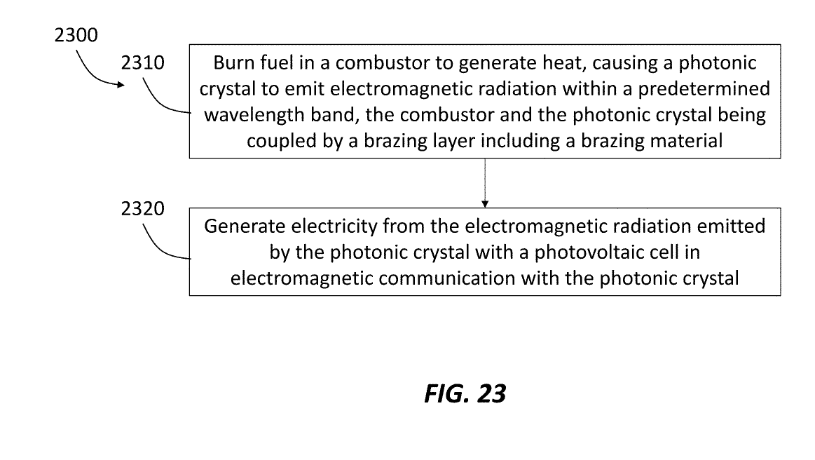

FIG. 23 illustrates a method 2300 of TPV energy conversion using an integrated TPV device. The method 2300 includes, at 2310, burning fuel in a combustor to generate heat. The heat causes a photonic crystal, in thermal communication with the combustor and made of a second metal, to emit electromagnetic radiation within a predetermined wavelength band. The combustor and the photonic crystal being coupled by a brazing layer made of a brazing material. The method also includes, at 2320, generating electricity from the electromagnetic radiation emitted by the photonic crystal with a photovoltaic cell in electromagnetic communication with the photonic crystal. The predetermined wavelength band can have a cutoff wavelength, and a significant portion of the electromagnetic radiation is at wavelengths below this cutoff wavelength. This cutoff wavelength is further matched with the band gap of the PV cell such that the PV cell can efficiently absorb the electromagnetic radiation for electricity conversion.

The combustion of the fuel can be carried out as follows. First, the combustor can be heated to a first temperature substantially equal to or greater than 400° C. with a heat source, such as a halogen lamp. The fuel is then delivered into the combustor that can include one or more serpentine channels coated with a catalyst on the inner wall to achieve self-sustaining thermal combustion of the fuel. At this point, the heat source can be turned off. In one example, the fuel includes propane and oxygen can be used as the oxidizer. In another example, air can be used as the oxidizer.

In some cases, the photonic crystal can be heated to a temperature substantially equal to or greater than 900° C. (e.g., about 900° C., about 1000° C., about 1100° C., about 1200° C., about 1300° C., about 1400° C., or greater, including any values and sub ranges in between). The photonic crystal and the combustor may be disposed in a vacuum chamber to reduce oxidation and heat loss due to convection (and/or conduction). The operating pressure in the vacuum chamber can be substantially equal to or less than 5×10⁻⁵ torr (e.g., about 5×10⁻⁵ torr, about 10⁻⁵ torr, about 5×10⁻⁶ torr, about 10⁻⁶ torr, or less, including any values and sub ranges in between). The vacuum chamber can include a window to transmit the electromagnetic radiation toward the PV cell disposed outside the vacuum chamber.

Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for generating electricity via thermophotovoltaic (TPV) energy conversion, the apparatus comprising:
a combustor to convert fuel into heat, the combustor comprising a first metal;
a photonic crystal, in thermal communication with the combustor, to emit electromagnetic radiation within a predetermined wavelength band in response to receiving the heat from the combustor, the photonic crystal comprising a second metal different from the first metal;
a brazing layer, disposed between the combustor and the photonic crystal, to couple the combustor with the photonic crystal, the brazing layer comprising a brazing material; and
a photovoltaic cell, in electromagnetic communication with the photonic crystal, to convert the electromagnetic radiation emitted by the photonic crystal into electricity.

2. The apparatus of claim 1, wherein the combustor comprises:
a metal substrate defining a serpentine channel to guide the fuel and an oxidizer, the serpentine channel having a first external wall, a second external wall opposite the first external wall, and an inner wall coated with a catalyst to facilitate combustion of the fuel;
a first metal plate disposed on the first external wall;
a first combustor brazing layer comprising the brazing material, disposed between the first external wall and the first metal plate, to couple the first external wall to the first metal plate;
a second metal plate disposed on the second external wall of the metal substrate; and
a second combustor brazing layer comprising the brazing material, disposed between the second external wall and the second metal plate, to couple the second external wall with the second metal plate.

3. The apparatus of claim 1, wherein the combustor has a thickness of about 5 mm to about 15 mm.

4. The apparatus of claim 1, wherein the first metal comprises Inconel.

5. The apparatus of claim 1, wherein the photonic crystal comprises:
a metal substrate comprising the second metal and defining a two-dimensional (2D) array of holes; and
dielectric material disposed in the 2D array of holes.

6. The apparatus of claim 5, wherein the metal substrate comprises tantalum and the dielectric material comprises HfO₂.

7. The apparatus of claim 5, wherein each hole in the 2D array of holes has a radius of about 0.15 μm to about 0.3 μm and a depth of about 2 μm to about 10 μm, and the predetermined wavelength band has a upper cutoff wavelength substantially equal to or less than 2.3 μm.

8. The apparatus of claim 1, wherein the first metal has a first melting temperature, the second metal has a second melting temperature, and the brazing material comprises a metal having a third melting temperature lower than the first melting temperature and the second melting temperature.

9. The apparatus of claim 1, wherein the brazing material comprises a third metal doped with a melting point depressant.

10. The apparatus of claim 9, wherein the metal comprises nickel and the melting point depressant comprises at least one of silicon, boron, or phosphorus.

11. The apparatus of claim 1, wherein the photonic crystal is a first photonic crystal disposed on a first side of the combustor and the photovoltaic cell is a first photovoltaic cell, and the apparatus further comprises:
a second photonic crystal, disposed on a second side, opposite the first side, of the combustor; and
a second photovoltaic cell in electromagnetic communication with the second photonic crystal.

12. The apparatus of claim 1, further comprising:
a vacuum chamber enclosing the combustor and the photonic crystal, the vacuum chamber comprising a window substantially transparent to the electromagnetic radiation,
wherein the photovoltaic cell is disposed outside the vacuum chamber and in electromagnetic communication with the photonic crystal via the window.

13. The apparatus of claim 12, wherein a pressure in the vacuum chamber is substantially equal to or less than 5×10⁻⁵ torr.

14. A method of thermophotovoltaic energy conversion, the method comprising:
burning fuel in a combustor to generate heat, the heat causing a photonic crystal, in thermal communication with the combustor and comprising a second metal, to emit electromagnetic radiation within a predetermined wavelength band, the combustor and the photonic crystal being coupled to each other by a brazing layer comprising a brazing material; and
generating electricity from the electromagnetic radiation emitted by the photonic crystal with a photovoltaic cell in electromagnetic communication with the photonic crystal.

15. The method of claim 14, wherein burning the fuel comprises:
heating the combustor to a first temperature substantially equal to or greater than 400 ° C. with a heat source;
delivering the fuel into a serpentine channel in the combustor, the serpentine channel having an inner wall coated with a catalyst to achieve self-sustaining thermal combustion of the fuel; and
turning off the heat source.

16. The method of claim 15, wherein delivering the fuel comprises delivering propane and air into the serpentine channel of the combustor.

17. The method of claim 14, wherein burning the fuel heats the photonic crystal to a temperature substantially equal to or greater than 900° C.

18. The method of claim 14, wherein the combustor and the photonic crystal are disposed in a vacuum chamber, and generating the electricity comprises:
receiving the electromagnetic radiation from the photonic crystal via a window in the vacuum chamber.

19. The method of claim 18, further comprising:
adjusting a pressure in the vacuum chamber to be substantially equal to or less than 5×10⁻⁵ torr.

20. A thermophotovoltaic device, comprising:
a combustor to convert fuel into heat, the combustor comprising:
a substrate comprising Inconel and defining a serpentine channel to guide the fuel, the serpentine channel having a first external wall and a second external wall opposite the first external wall;
a first metal plate coupled to the first external wall by a first brazing layer; and
a second metal plate coupled to the second external wall by a second brazing layer, the first metal plate and the second metal plate substantially sealing the combustor;
a photonic crystal, in thermal communication with the combustor, to convert the heat from the combustor into electromagnetic radiation within a predetermined wavelength band, the photonic crystal comprising:
a metal substrate defining a two-dimensional (2D) array of holes; and
dielectric material disposed in the 2D array of holes; and
a third brazing layer, disposed between the combustor and the photonic crystal, to couple the combustor with the photonic crystal, the third brazing layer comprising a brazing material diffused into at least one of the combustor or the photonic crystal, the brazing material comprising nickel doped with at least one of silicon or boron; and
a photovoltaic cell, in electromagnetic communication with the photonic crystal, to convert the electromagnetic radiation emitted by the photonic crystal into electricity.
